(19) United States
(12) Patent Application Publication
(10) Pub. No.: US 2026/0003075 A1
(43) Pub. Date: Jan. 1, 2026

(54) SIGNAL PROCESSING APPARATUS, SIGNAL PROCESSING METHOD, AND INFORMATION PROCESSING APPARATUS

(71) Applicant: Sony Semiconductor Solutions Corporation, Kanagawa (JP)

(72) Inventors: Kazutoshi KITANO, Kanagawa (JP); Yuusuke KAWAMURA, Kanagawa (JP); Kousuke TAKAHASHI, Kanagawa (JP)

(73) Assignee: Sony Semiconductor Solutions Corporation, Kanagawa (JP)

(21) Appl. No.: 18/878,655

(22) PCT Filed: Jul. 21, 2023
(86) PCT No.: PCT/JP2023/026725

§ 371 Date: Dec. 24, 2024

(30) Foreign Application Priority Data
Jul. 29, 2022 (JP) 2022-122136

(51) Int. Cl. G01S 17/89; G01S 17/32; G01S 17/58; G01S 17/86

(52) U.S. Cl. CPC G01S 17/89; G01S 17/32; G01S 17/58; G01S 17/86

(57) ABSTRACT

A signal processing apparatus according to an embodiment includes: a reception unit configured to receive velocity point cloud data from a first sensor, the velocity point cloud data including a plurality of points, each point having velocity information and time-point information; a correction unit that corrects at least one attribute value related to at least one point included in the velocity point cloud data, the correction made based on an estimated value at a predetermined time-point; and a transmission unit configured to add corrected time-point information indicating the predetermined time-point to the attribute value corrected by the correction unit and transmits the corrected attribute value together with the corrected time-point information.

### FIELD

The present disclosure relates to a signal processing apparatus, a signal processing method, and an information processing apparatus.

### BACKGROUND

One known method of performing ranging, that is, distance measurement using light, is a technology referred to as Frequency Modulated Continuous Wave-Laser Imaging Detection and Ranging (FMCW-LiDAR). FMCW-LiDAR performs distance measurement by performing coherent detection on a reception signal obtained by combining laser light, which is emitted as chirp light in which the frequency of a pulse is linearly changed with the lapse of time, and reflected light of the emitted laser light. By using the Doppler effect, FMCW-LiDAR can perform velocity measurement simultaneously with distance measurement.

### CITATION LIST

### Patent Literature

Patent Literature 1: US 2020/0292706 A
Patent Literature 2: US 2020/0040082 A
Patent Literature 3: WO 2019/239566 A

### SUMMARY

### Technical Problem

In typical FMCW-LiDAR, since the measurement result is acquired for each direction of the laser light emitted for sequential scanning, the acquisition time of the measurement result differs at each measurement point, in principle. Therefore, the existing technology has had difficulty in meeting a demand for obtaining a measurement result at the same time for the whole or part of the point cloud, having difficulty in achieving universal use of the measurement result.

An object of the present disclosure is to provide a signal processing apparatus, a signal processing method, and an information processing apparatus that enable more universal use of a measurement result obtained by FMCW-LiDAR.

### Solution to Problem

For solving the problem described above, a signal processing apparatus according to one aspect of the present disclosure has a reception unit configured to receive velocity point cloud data from a first sensor, the velocity point cloud data including a plurality of points, each point having velocity information and time-point information; a correction unit configured to correct at least one attribute value related to at least one point included in the velocity point cloud data, based on an estimated value at a predetermined time-point; and a transmission unit configured to add corrected time-point information indicating the predetermined time-point, to the attribute value corrected by the correction unit and transmit the corrected attribute value together with the corrected time-point information.

### BRIEF DESCRIPTION OF DRAWINGS

FIG. 1 is a block diagram schematically illustrating a configuration example of a signal processing system according to an embodiment.

FIG. 2 is a block diagram illustrating a configuration of an example of a signal processing system according to an embodiment in more detail.

FIG. 3 is a block diagram illustrating a configuration of an example of a light detection and ranging sensor according to the embodiment.

FIG. 4 is a schematic diagram schematically illustrating an example of a scan pattern of a transmission light signal according to the embodiment.

FIG. 5A is a schematic diagram schematically illustrating another example of the scan pattern of the transmission light signal.

FIG. 5B is a schematic diagram schematically illustrating still another example of the scan pattern of the transmission light signal.

FIG. 6 is a schematic diagram schematically illustrating velocity point cloud correction processing according to the embodiment.

FIG. 7 is a block diagram illustrating a hardware configuration of an example of a signal processing system applicable to the embodiment.

FIG. 8 is a schematic diagram illustrating an example of a data format specified in MIPI-CSI-2, applicable to the embodiment.

FIG. 9 is a schematic diagram illustrating another example of a data format specified in MIPI-CSI-2, applicable to the embodiment.

FIG. 10 is a schematic diagram illustrating an example of transmission of a point cloud using a data format specified in MIPI-CSI-2, applicable to the embodiment.

FIG. 11 is a schematic diagram illustrating an example in which Ethernet is applied as an interface related to data transmission between units applicable to the embodiment.

FIG. 12 is a diagram illustrating an example of an architecture of a signal processing unit according to the embodiment.

FIG. 13 is a flowchart of an example illustrating transmission light signal detection processing in the light detection and ranging sensor, applicable to the embodiment.

FIG. 14 is a schematic diagram for illustrating a transmission light signal transmitted by a light transmission/reception unit, applicable to the embodiment.

FIG. 15 is a schematic diagram for illustrating determination processing on a reception light signal according to the embodiment.

FIG. 16 is a schematic diagram illustrating an example of data output in a case where the light detection and ranging sensor according to the embodiment performs scanning with a raster scan pattern.

FIG. 17 is a schematic diagram for illustrating a frame definition applicable to the embodiment.

FIG. 18A is a schematic diagram for illustrating an output timing of each data by a sensor unit according to the embodiment.

FIG. 18B is a schematic diagram for illustrating an output timing of each data by a sensor unit according to the embodiment.

FIG. 19 is a schematic diagram illustrating an example of a data format of FMCW-LiDAR data and IMU data output from a sensor unit according to the embodiment.

FIG. 20 is a schematic diagram illustrating an example of output data by the light detection and ranging sensor according to the embodiment.

FIG. 21 is a schematic diagram illustrating a definition of coordinates of an emission point, applicable to the embodiment.

FIG. 22 is a schematic diagram illustrating each emission point and an object as viewed from a light detection and ranging sensor.

FIG. 23 is a schematic diagram illustrating an overall flow of processing related to point cloud correction in the signal processing unit according to the embodiment.

FIG. 24 is a flowchart of an example illustrating processing related to point cloud correction in the signal processing unit according to the embodiment.

FIG. 25 is a flowchart illustrating an example of correction processing of a velocity point cloud frame of a stationary object in the signal processing unit according to the embodiment.

FIG. 26 is a schematic diagram for defining a coordinate system and each variable.

FIG. 27 is a block diagram illustrating a configuration of an example of a signal processing system according to a first modification of the embodiment.

FIG. 28 is a block diagram illustrating a configuration of an example of a signal processing system according to a second modification of the embodiment.

### DESCRIPTION OF EMBODIMENTS

Embodiments of the present disclosure will be described below in detail with reference to the drawings. In each of the following embodiments, the same parts are denoted by the same reference symbols, and a repetitive description thereof will be omitted.

Hereinafter, embodiments of the present disclosure will be described in the following order.
1. Outline of embodiment according to present disclosure
2. More specific description of embodiment according to present disclosure
   2-1. Configuration according to embodiment
      2-1-1. Sensor unit
         2-1-1-1. Light detection and ranging sensor
      2-1-2. Signal processing unit
         2-1-2-1. Library section
         2-1-2-2. Application section
      2-2-1. System configuration
   2-2. Processing according to embodiment
      2-2-1. Measurement technique applicable to embodiment
      2-2-2. Example of data structure according to embodiment
      2-2-3. Point cloud correction processing according to embodiment
3. First modification of embodiment of present disclosure
4. Second modification of embodiment of present disclosure
5. Other embodiments according to present disclosure

### (1. Outline of Embodiment According to Present Disclosure)

First, an embodiment according to the present disclosure will be schematically described.

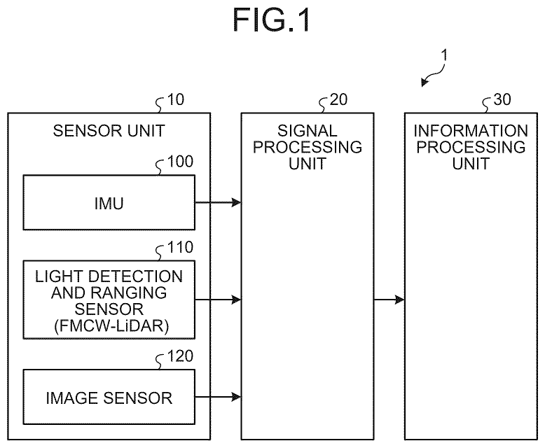

FIG. 1 is a block diagram schematically illustrating a configuration example of a signal processing system according to the embodiment. In FIG. 1, a signal processing system 1 includes a sensor unit 10, a signal processing unit 20, and an information processing unit 30.

The sensor unit 10 includes an inertial measurement unit (IMU) 100, a light detection and ranging sensor 110, and an image sensor 120. The IMU 100 includes, for example, a triaxial acceleration sensor, a triaxial angular velocity sensor, and a triaxial geomagnetic sensor, and outputs inertial measurement data (hereinafter, appropriately referred to as IMU data) obtained by these sensors. The light detection and ranging sensor 110 is a sensor that performs ranging using light, and the embodiment employs Frequency Modulated Continuous Wave-Laser Imaging Detection and Ranging (FMCW-LiDAR), a method that performs ranging using frequency modulated continuous laser light. The image sensor 120 is typically a camera, images a subject, and outputs image data including information of red (R), green (G), and blue (B), for example.

In FIG. 1, the signal processing unit 20 receives input of data including: IMU data output from the IMU 100 of the sensor unit 10; FMCW-LiDAR data output from the light detection and ranging sensor 110; and image data output from the image sensor 120. The signal processing unit 20 performs signal processing based on the input IMU data, the FMCW-LiDAR data, and the image data. The signal processing unit 20 performs signal processing based on each data and generates, for example, map information, a velocity point cloud of each of a stationary object and a moving object, motion meta-information indicating motion of the moving object, and image meta-information related to an image in a region of interest. The signal processing unit 20 outputs the generated information to the information processing unit 30.

The information processing unit 30 performs predetermined processing in accordance with each piece of information output from the signal processing unit 20. The processing performed by the information processing unit 30 in accordance with each piece of information output from the signal processing unit 20 is not particularly limited. For example, in a case where the signal processing system 1 is applied to an autonomously operating robot (mobile body), the information processing unit 30 may perform drive control of the robot based on map information or the like. Furthermore, for example, in a case where the signal processing system 1 is applied to a control system of a monitoring camera, the information processing unit 30 may perform notification or the like based on the motion meta-information or the image meta-information.

Furthermore, the information processing unit 30 may transmit an instruction related to signal processing to the signal processing unit 20. The signal processing unit 20 may control processing for the output of the sensor unit 10 in accordance with this instruction. In addition, the signal processing unit 20 may control the operations of the sensors (the IMU 100, the light detection and ranging sensor 110, and the image sensor 120 in the sensor unit 10 in accordance with this instruction. Note that the information processing unit 30 may be implemented by applying a configuration as a typical computer including a central processing unit (CPU), memory, a storage device, and the like.

In this manner, the signal processing system 1 according to the embodiment can output various data based on the measurement result by the FMCW-LiDAR, making it possible to further universally utilize the measurement result of the FMCW-LiDAR.

### (2. More Specific Description of Embodiment According to Present Disclosure)

Next, the embodiment according to the present disclosure will be described more specifically.

### (2-1. Configuration According to Embodiment)

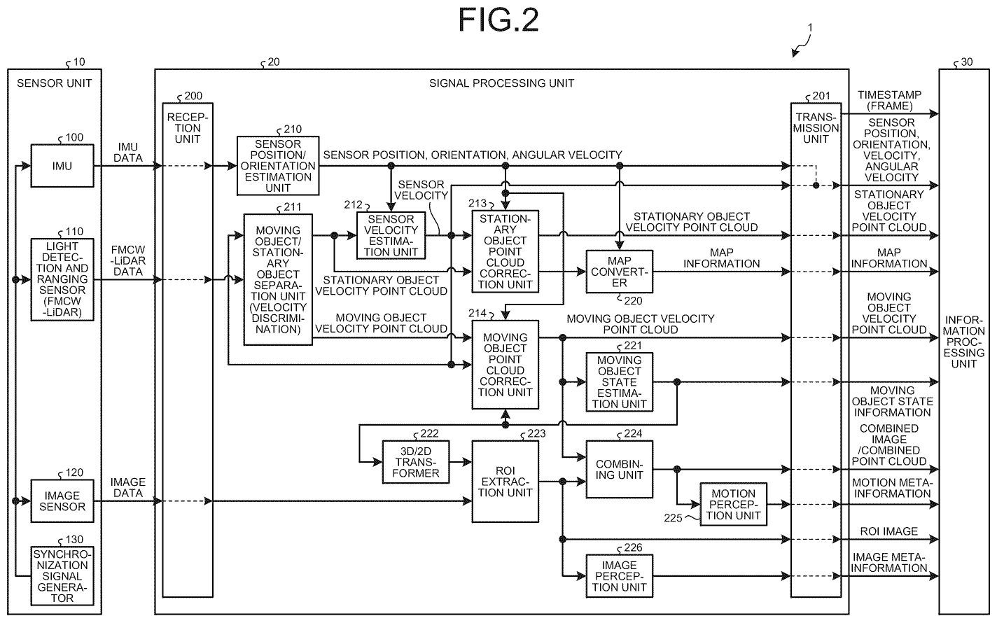

First, the configuration of the embodiment will be described more specifically. FIG. 2 is a block diagram illustrating a configuration of an example of the signal processing system 1 according to an embodiment in more detail.

### (2-1-1. Sensor Unit)

In FIG. 2, the sensor unit 10 includes an IMU 100, a light detection and ranging sensor 110 using FMCW-LiDAR, an image sensor 120, and a synchronization signal generator 130.

The synchronization signal generator 130 generates a synchronization signal. The synchronization signal may be a pulse of a predetermined period. The synchronization signal generator 130 supplies the generated synchronization signal to the IMU 100, the light detection and ranging sensor 110, and the image sensor 120. Operation and data output timing of each of the IMU 100, the light detection and ranging sensor 110, and the image sensor 120 are controlled in synchronization with the supplied synchronization signal.

The IMU 100 includes a triaxial acceleration sensor, a triaxial angular velocity sensor, and a triaxial geomagnetic sensor. The IMU 100 outputs sensor data obtained by the triaxial acceleration sensor, the triaxial angular velocity sensor, and the triaxial geomagnetic sensor, as IMU data. The IMU 100 may add a timestamp indicating an acquisition time of the IMU data, and may output the IMU data with the timestamp.

The image sensor 120 is typically a camera, images a subject, and outputs image data including information of red (R), green (G), and blue (B), for example. The image sensor 120 includes: a pixel array in which pixels that output pixel signals as electric signals according to received light are arranged in a matrix array; and a drive circuit that drives each pixel of the pixel array. The image sensor 120 converts each pixel signal output as an analog signal from each pixel of the pixel array into digital pixel data and outputs the obtained digital pixel data. The pixel data based on the output of each pixel included in an effective region of the pixel array constitutes image data of one frame.

Note that, although not illustrated, the sensor unit 10 includes an interface unit that controls input/output of data of the IMU 100, the light detection and ranging sensor 110, and the image sensor 120. The configuration is not limited thereto, and the IMU 100, the light detection and ranging sensor 110, and the image sensor 120 may each include individual interface units as separate units.

### (2-1-1-1. Light Detection and Ranging Sensor)

The light detection and ranging sensor 110 is a sensor that performs distance measurement using light, and applies FMCW-LiDAR in the embodiment. The laser light to be emitted by the FMCW-LiDAR is, for example, chirp light in which the frequency of a pulse is linearly changed in accordance with the lapse of time. The FMCW-LiDAR performs distance measurement by performing coherent detection on a reception signal obtained by combining a part of laser light emitted as chirp light or local oscillator light synchronized with the laser light and reflected light of the emitted laser light.

The FMCW-LiDAR utilizes the Doppler effect, thereby making it possible to perform velocity (Doppler velocity) measurement simultaneously with distance measurement. Therefore, by using the FMCW-LiDAR, it is easy to quickly grasp the position of an object having a velocity, such as a person or another moving object. In addition, the coherent detection is less likely to suffer interference from other light sources, making it possible to avoid inter-channel crosstalk, and furthermore, has less influence of noise due to a light source with high illuminance such as sunlight. In addition, since the FMCW-LiDAR is an active measurement, it is possible to perform measurement even in a low illuminance environment such as a dark environment.

In addition, FMCW-LiDAR typically performs scanning at a laser emission direction set in a predetermined angular range in a horizontal direction, for example, and further performs scanning in a predetermined angular range in a vertical direction, with the laser light emitted at each predetermined angle of scanning to perform measurement. Therefore, the measurement result by the FMCW-LiDAR is acquired as point information for each scanning angle. The information of each measured point may include, as attribute information (attribute value), the distance according to the ranging result, the Doppler velocity, and the intensity of the received reflected light. The attribute information can include the intensity of each orthogonal polarization component of the reflected light depending on the configuration of the reception device. In addition, a set of points having three-dimensional or two-dimensional spatial coordinates is referred to as a point cloud, and a point cloud in which each point includes velocity information (Doppler velocity) is referred to as a velocity point cloud.

The light detection and ranging sensor 110 outputs the information indicating the distance, the Doppler velocity, and the intensity as FMCW-LiDAR data in association with a timestamp indicating the acquisition time of these pieces of information and information indicating the emission direction of the laser light (horizontal scanning angle and vertical scanning angle). That is, the FMCW-LiDAR data includes a velocity point cloud.

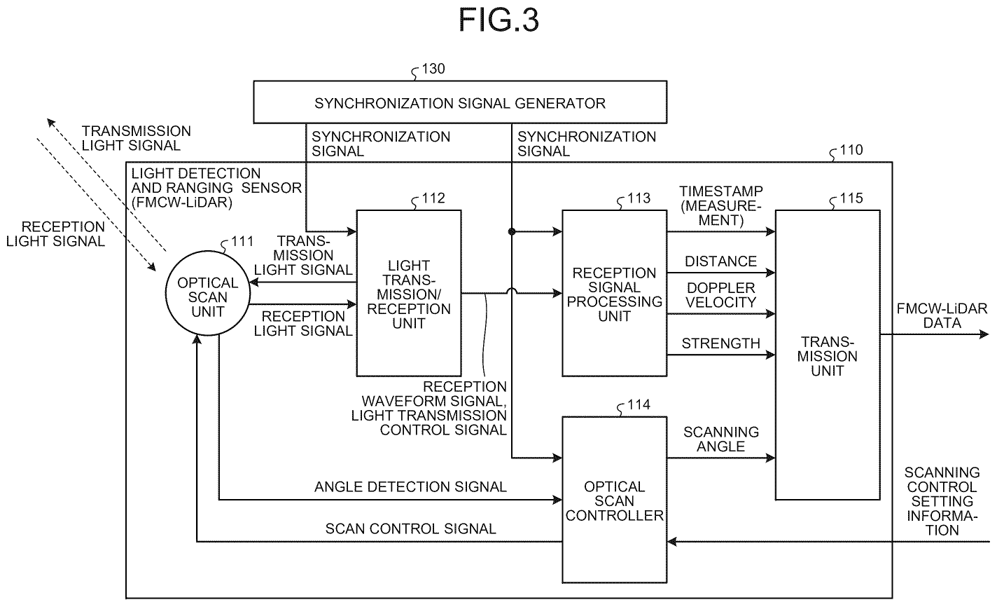

FIG. 3 is a block diagram illustrating a configuration of an example of the light detection and ranging sensor 110 according to the embodiment. In FIG. 3, the light detection and ranging sensor 110 includes an optical scan unit 111, a light transmission/reception unit 112, a reception signal processing unit 113, an optical scan controller 114, and a transmission unit 115.

The light transmission/reception unit 112 includes: a light transmission unit that generates a transmission light signal transmitted from the optical scan unit 111 described below; a transmission light controller that controls the transmission light generated by the light transmission unit; and a light reception unit that receives (receives) a reception light signal from the optical scan unit 111.

In the light transmission/reception unit 112, the light transmission unit includes: a light source such as a laser diode for oscillating laser light which is transmission light; an optical system for emitting light oscillated by the light source; and a laser output modulator for driving the light source, for example. The light transmission unit uses the light source to perform light oscillation in accordance with the light transmission control signal supplied from the transmission light controller, and emits a transmission light signal by chirp light whose frequency linearly changes within a predetermined frequency range with the lapse of time. The transmission light signal is transmitted to the optical scan unit 111, and together with this, is transmitted to the light reception unit as local oscillator light.

In the light transmission unit, the transmission light controller generates a signal whose frequency linearly changes (increases and decreases) within a predetermined frequency range with the lapse of time. Such a signal whose frequency linearly changes within a predetermined frequency range with the lapse of time is referred to as a chirp signal. Based on the chirp signal, the transmission light controller generates a light transmission control signal being a modulation synchronization timing signal to be input to the laser output modulator included in the light transmission unit. The transmission light controller generates the light transmission control signal as a signal synchronized with the synchronization signal supplied from the synchronization signal generator 130. The transmission light controller passes the generated light transmission control signal to the light transmission unit and a reception signal processing unit 113 to be described below.

In the light transmission/reception unit 112, the light reception unit includes: for example, a light receiver that receives a reception light signal (performs light reception) from the optical scan unit 111; and a drive circuit that drives the light receiver. For example, the light receiver can be implemented by applying a configuration combining a condenser lens and a light receiving element such as a photodiode. The light reception unit further includes a light combiner that combines the reception light received from the scan unit with the local oscillator light transmitted from the light transmission unit. When the reception light is reflected light from a target of the transmission light, the reception light is a signal delayed in accordance with the distance to the object, as compared with the local oscillator light, and thus, the combined signal obtained by combining the reception light and the local oscillator light is to be a signal (beat signal) having a constant frequency. The light transmission/reception unit 112 passes this signal to the reception signal processing unit 113 as a reception waveform signal.

The reception signal processing unit 113 performs predetermined signal processing such as fast Fourier transform on the reception signal passed from the light transmission/reception unit 112 in synchronization with the synchronization signal supplied from the synchronization signal generator 130. With this signal processing, the reception signal processing unit 113 acquires a distance to the target, the Doppler velocity of the target, and the strength of the reception light signal. The reception signal processing unit 113 adds a timestamp generated in synchronization with the synchronization signal to the acquired distance, velocity, and Doppler velocity, and passes the data with the timestamp to the transmission unit 115. The timestamp here is a timestamp related to measurement, indicating the timing at which the transmission light signal has been transmitted by the light transmission/reception unit 112, and is generated and added for each measurement.

The optical scan controller 114 generates a scan control signal for controlling scanning of the transmission light signal in the optical scan unit 111. At this time, the optical scan controller 114 generates the scan control signal so that the scanning of the transmission light signal is synchronized with the synchronization signal supplied from the synchronization signal generator 130. The optical scan controller 114 may generate a scan control signal for performing scanning in a predetermined scanning range, or may generate a scan control signal in accordance with scan control information transmitted from a control communication unit 230 described below.

In addition, the optical scan controller 114 receives an angle detection signal indicating a scanning angle of the transmission light signal from the optical scan unit 111. The optical scan controller 114 passes information indicating the scanning angle to the transmission unit 115 based on the received angle detection signal.

The optical scan unit 111 transmits a transmission light signal sent from the light transmission/reception unit 112, the transmission being performed at an angle according to a scan pattern corresponding to the scan control signal supplied from the optical scan controller 114, and receives light incident from the angle, and outputs the light as a reception light signal. In the optical scan unit 111, the scanning mechanism of the transmission light signal can be implemented by applying a biaxial mirror scanner, for example. In this case, the scan control signal is, for example, a drive voltage signal applied to each axis of the biaxial mirror scanner.

In addition, the optical scan unit 111 detects angles in the horizontal direction and the vertical direction at which the transmission light signal is transmitted, and outputs an angle detection signal indicating the detected angle.

The transmission unit 115 transmits the timestamp, the distance, the Doppler velocity, and the strength passed from the reception signal processing unit 113 and the scanning angle passed from the optical scan controller 114 to the signal processing unit 20 as FMCW-LiDAR data. That is, the FMCW-LiDAR data includes a timestamp for each measurement point of the light detection and ranging sensor 110.

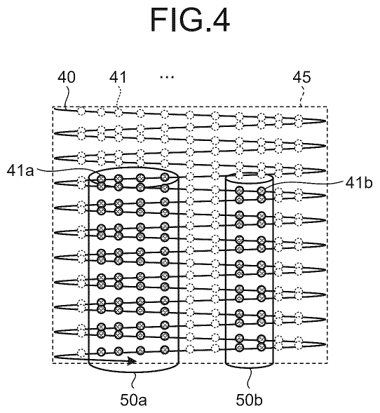

FIG. 4 is a schematic diagram schematically illustrating an example of a scan pattern of a transmission light signal according to the embodiment. FIG. 4 illustrates an example of a raster scan pattern among the scan patterns. The optical scan unit 111 performs scanning within a predetermined angular range 45 along a scanning line 40 that is folded back at both ends of the angular range 45 in the horizontal direction. The scanning line 40 corresponds to one trajectory obtained by scanning between the left end and the right end of the angular range 45. The optical scan unit 111 scans between the upper end and the lower end of the angular range 45 following the scanning line 40 in accordance with the scan control signal.

In accordance with the scan control signal, the optical scan unit 111 sequentially and discretely changes an emission point 41 of the chirp light as the transmission light signal along the scanning line 40 at constant time intervals (point rate), for example. The emission points 41 within the angular range 45 constitute one frame in the FMCW-LiDAR. The scanning time from the upper end to the lower end of the angular range 45 forms 1 frame time span. The transmission light signal at each emission point 41 is sequentially emitted at predetermined time intervals in one frame according to the scanning line 40. Therefore, the measurement data at each of the emission points 41 is acquired at different time-point for each of the emission points 41 according to the scanning order.

In the vicinity of the turning points at the left end and the right end of the angular range 45 of the scanning line 40, the scanning velocity by the biaxial mirror scanner decreases. Therefore, the individual emission points 41 are not arranged in a lattice pattern in the angular range 45.

Among the emission points 41, for example, at emission points 41a and 41b (illustrated as solid points) corresponding to the positions where the objects 50a and 50b exist, the emitted transmission light signal is reflected by objects 50a and 50b, and the reflected light is returned as a reception light signal. On the other hand, among the emission points 41, at an emission point 41 corresponding to a position where no objects 50a and 50b exist, reflected light is not obtained, and thus a reception light signal is not obtained.

Note that the light transmission/reception unit 112 may emit a transmission light signal one or a plurality of times to one emission point 41. In addition, the light transmission/reception unit 112 emits a transmission light signal by chirp light whose frequency continuously changes in time series at each emission point 41, while the optical scan unit 111 continuously changes the scanning angle. Therefore, the transmission light signal is applied to the object in an elliptical shape along the scanning line 40, for example.

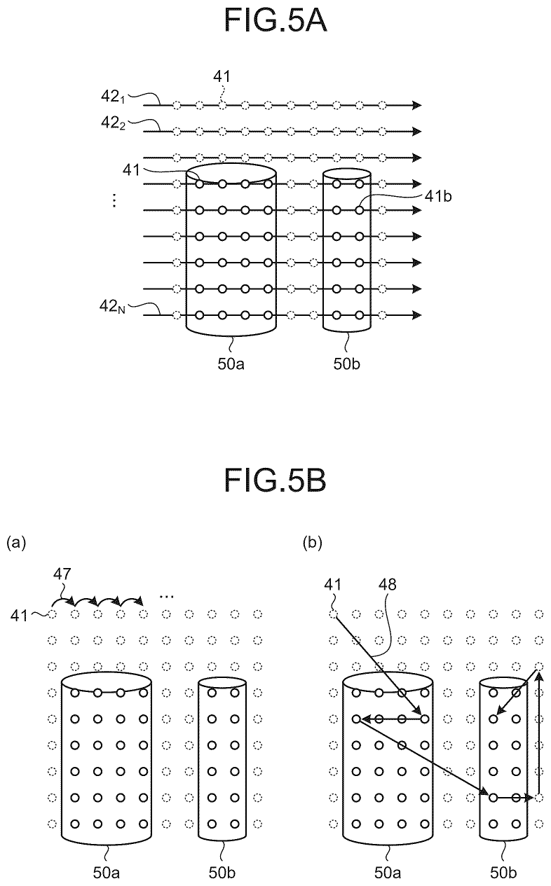

The scan pattern of the transmission light signal is not limited to the above-described raster scan pattern. FIGS. 5A and 5B are schematic diagrams schematically illustrating another example of the scan pattern of the transmission light signal.

FIG. 5A illustrates an example of a multi-layer scan pattern among the scan patterns. In the multi-layer scan, scanning of a plurality of lines is simultaneously performed by rotating a plurality of beams by 360°. More specifically, in the multi-layer scan, the emission point 41 of the transmission light signal is sequentially and discretely changed at constant time intervals along scanning lines 42₁, 42₂, . . . , and 42_{N} individually by the plurality of beams. In the multi-layer scan, folding of the scanning lines 42₁, 42₂, . . . and 42_{N} does not occur, facilitating arrangement of the emission points 41 in a lattice pattern.

FIG. 5B illustrates an example of a dot scanning scan pattern among the scan patterns. In the dot scanning, the beam scanning trajectory is not continuous but discrete, as it is fixed at each emission point 41. At each emission point 41, a transmission light signal is emitted, and after reception of the reflected light signal is complete, the beam is switched to the next emission point 41. In FIG. 5B, section (a) illustrates an example in which beam switching is sequentially executed according to a prescribed sequence as indicated by arrow 47 in the figure. Furthermore, section (b) illustrates an example in which the beam switching is executed in an arbitrary order by the scan control setting from the signal processing unit 20, for example, as indicated by arrow 48 in the figure. In the example of section (b), only a predetermined region of the entire scanning region may be scanned by the scanning control setting, and the predetermined region may be set in plurality in one frame. Furthermore, the predetermined region may be decided based on the position of the detected moving object or stationary object.

### (2-1-2. Signal Processing Unit)

Returning to FIG. 2, each configuration included in the signal processing unit 20 can be roughly divided into a section (referred to as a library section) that provides individual functions and a section (referred to as an application section) that executes target processing using the functions provided by the section.

In FIG. 2, the library section includes, for example, a reception unit 200, a sensor position/orientation estimation unit 210, a moving object/stationary object separation unit 211, a sensor velocity estimation unit 212, a stationary object point cloud correction unit 213, and a moving object point cloud correction unit 214. Furthermore, the application section includes, for example, a map converter 220, a moving object state estimation unit 221, a 3D/2D transformer 222, a Region of Interest (ROI) extraction unit 223, a combining unit 224, a motion perception unit 225, and an image perception unit 226.

In the signal processing unit 20, the configurations included in the library section and the application section are not limited to the above-described examples. For example, the moving object state estimation unit 221, or the moving object state estimation unit 221 and the 3D/2D transformer 222 may be included in the library section. In addition, a transmission unit 201 may be included in either the library section or the application section, or may be the section not included in either of them. The reception unit 200 may also be included in the application section, may be included in either the library section or the application section, or may be the section not included in either of them.

### (2-1-2-1. Library Section)

First, the library section of the signal processing unit 20 will be described.

In the library section, the reception unit 200 receives each data output from the sensor unit 10 and passes the received data to each unit of the signal processing unit 20. More specifically, the reception unit 200 passes the IMU data output from the IMU 100 of the sensor unit 10 to the sensor position/orientation estimation unit 210. The reception unit 200 also passes the FMCW-LiDAR data output from the light detection and ranging sensor 110 of the sensor unit 10 to the moving object/stationary object separation unit 211. Furthermore, the reception unit 200 passes the image data output from the image sensor 120 of the sensor unit 10 to the ROI extraction unit 223.

In this manner, the reception unit 200 functions as a reception unit that receives the velocity point cloud data, which includes the plurality of points each having the velocity information and time-point information.

The sensor position/orientation estimation unit 210 estimates the position, orientation, and angular velocity of the IMU 100 based on the IMU data passed from the reception unit 200. For example, the sensor position/orientation estimation unit 210 estimates the current position, orientation, and angular velocity of the IMU 100 by performing sensor fusion processing such as a Kalman filter, for example, using each sensor data by the triaxial acceleration sensor, the triaxial angular velocity sensor, and the triaxial geomagnetic sensor, included in the IMU data. The sensor position/orientation estimation unit 210 preliminarily acquires calibration data such as a positional relationship of the reference coordinate system of the light detection and ranging sensor 110 with respect to the reference coordinate system of the IMU 100 and internal parameters of each sensor, and uses the prepared calibration data at the time of estimation. The sensor position/orientation estimation unit 210 passes data of the estimated sensor position, orientation, and angular velocity to the sensor velocity estimation unit 212, the map converter 220, and the transmission unit 201.

The moving object/stationary object separation unit 211 receives the FMCW-LiDAR data from the reception unit 200, and also receives the sensor velocity indicating the velocity of the light detection and ranging sensor 110 estimated by the sensor velocity estimation unit 212 to be described below. Using velocity discrimination based on the Doppler velocity and the sensor velocity included in the passed FMCW-LiDAR data, the moving object/stationary object separation unit 211 separates the velocity point cloud indicated by the FMCW-LiDAR data into a velocity point cloud by a moving object and a velocity point cloud by a stationary object. The moving object/stationary object separation unit 211 may extract the moving object velocity point cloud and the stationary object velocity point cloud from the FMCW-LiDAR data corresponding to the scan for one frame.

For example, the moving object/stationary object separation unit 211 subtracts an optical axis direction component of the sensor velocity from the Doppler velocity of each measurement point included in the FMCW-LiDAR data to eliminate the influence of the movement of the sensor unit 10 from the velocity information of the velocity point cloud, and obtains the corrected Doppler velocity of each measurement point viewed from the coordinate system of the stationary object. That is, the corrected Doppler velocity is the velocity obtained by excluding the influence of the movement of the sensor unit 10 from the Doppler velocity included in the FMCW-LiDAR data. The moving object/stationary object separation unit 211 performs threshold determination on the magnitude of the corrected Doppler velocity, and extracts, as a moving object velocity point cloud, a velocity point cloud (referred to as a localized velocity point cloud) based on measurement points localized in a certain spatial range (corresponding to the size of the target object) among measurement points with a size being the threshold or more. The moving object/stationary object separation unit 211 may extract a plurality of moving object velocity point clouds from one frame of FMCW-LiDAR data.

In addition, the moving object/stationary object separation unit 211 performs threshold determination on the magnitude of the corrected Doppler velocity for the measurement points based on the FMCW-LiDAR data. As a result of the threshold determination, the moving object/stationary object separation unit 211 extracts a set of measurement points at which the magnitude of the corrected Doppler velocity is the threshold or less as a stationary object velocity point cloud.

Here, in this threshold determination, the moving object/stationary object separation unit 211 may provide two types of thresholds: a threshold vₜₕₐ and a threshold v_{thb}(<vₜₕₐ). The moving object/stationary object separation unit 211 may extract a measurement point at which the magnitude of the corrected Doppler velocity is the threshold vₜₕₐ or more as a moving object velocity point cloud and may extract a measurement point at which the magnitude of the corrected Doppler velocity is the threshold v_{thb} or less as a stationary object velocity point cloud. This means that there is an intermediate point cloud that does not belong to either the moving object velocity point cloud or the stationary object velocity point cloud. For the purpose of extracting clearly stationary measurement points, it is appropriate to provide two types of thresholds in this manner.

Note that a point cloud frame is constituted by the velocity point cloud obtained from the FMCW-LiDAR data of one frame.

The moving object/stationary object separation unit 211 passes the extracted stationary object velocity point cloud to the sensor velocity estimation unit 212 and the stationary object point cloud correction unit 213. In addition, the moving object/stationary object separation unit 211 passes the extracted moving object velocity point cloud to the moving object point cloud correction unit 214.

The sensor velocity estimation unit 212 estimates the sensor velocity indicating the velocity of the sensor unit 10 based on the stationary object point cloud passed from the moving object/stationary object separation unit 211 and the sensor position, orientation, and angular velocity passed from the sensor position/orientation estimation unit 210. A specific example of the estimation processing of the sensor velocity by the sensor velocity estimation unit 212 will be described below.

The sensor velocity estimation unit 212 passes the estimated sensor velocity to the stationary object point cloud correction unit 213 and the moving object/stationary object separation unit 211, and together with this operation, inputs the estimated sensor velocity to the moving object/stationary object separation unit 211. The sensor velocity estimation unit 212 passes the estimated sensor velocity to the transmission unit 201.

The stationary object point cloud correction unit 213 corrects the stationary object velocity point cloud using the sensor position, orientation, and angular velocity passed from the sensor position/orientation estimation unit 210 and the sensor velocity passed from the sensor velocity estimation unit 212. The moving object point cloud correction unit 214 corrects the moving object velocity point cloud by using the sensor position, orientation, and angular velocity passed from the sensor position/orientation estimation unit 210, the sensor velocity passed from the sensor velocity estimation unit 212, and information indicating the state of the moving object passed from the moving object state estimation unit 221 described below.

As described above, in the FMCW-LiDAR, the acquisition time of the measurement data at each measurement point in the frame varies depending on the position of the measurement point in the frame depending on the type of the scan pattern. The stationary object point cloud correction unit 213 and the moving object point cloud correction unit 214 estimate data of each point in a case where each point of the velocity point cloud in the frame is acquired at the same predetermined time, and correct the velocity point cloud in accordance with the estimation result.

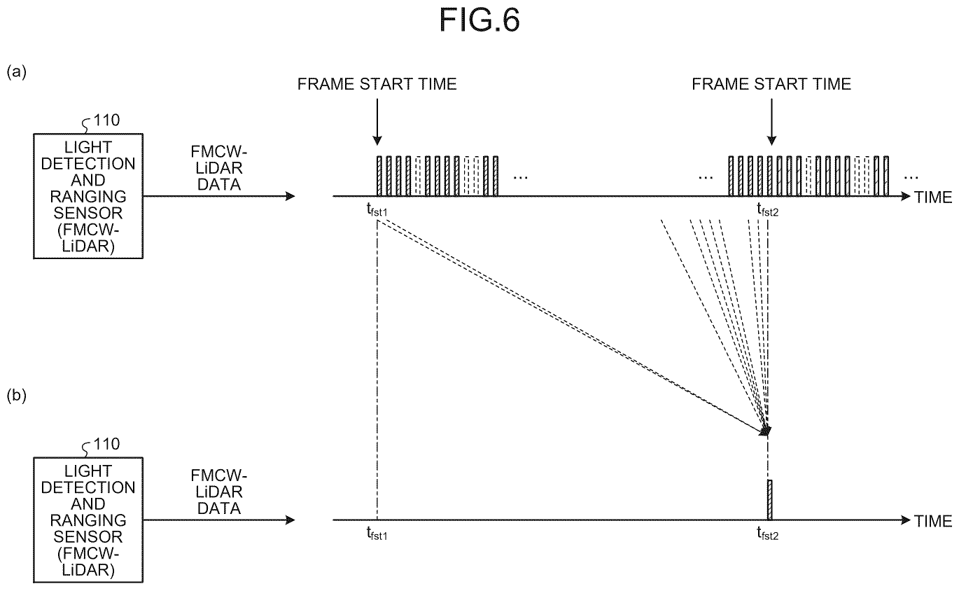

FIG. 6 is a schematic diagram schematically illustrating velocity point cloud correction processing according to the embodiment. In FIG. 6, a section (a) illustrates an example of an output timing of the FMCW-LiDAR data output from the light detection and ranging sensor 110. As illustrated in this figure, the FMCW-LiDAR data is output at constant time intervals from the frame start time t_{fst1} to the next frame start time t_{fst2}. Each point of the velocity point cloud based on the FMCW-LiDAR data has time information corresponding to the output timing of each data.

In the figure, data corresponding to the emission point 41 corresponding to the position where the objects 50a and 50b (refer to FIG. 4) and the like exist is indicated by a solid line (hatched). In addition, data corresponding to the emission point 41 corresponding to a position where no objects 50a and 50b exist is indicated by a dotted line. The data indicated by the dotted line indicates that nothing is actually detected as an object from the reception light signal.

In FIG. 6, section (b) schematically illustrates a state in which the FMCW-LiDAR data output from the light detection and ranging sensor 110 is corrected by the stationary object point cloud correction unit 213 and the moving object point cloud correction unit 214. The stationary object point cloud correction unit 213 and the moving object point cloud correction unit 214 estimate a value at a time serving as a reference for correction of each FMCW-LiDAR data from the frame start time t_{fst1} to the frame start time t_{fst2}, for example, at the frame start time t_{fst2}, based on the sensor position, orientation, and angular velocity, and the sensor velocity, for example. The stationary object point cloud correction unit 213 and the moving object point cloud correction unit 214 individually correct the stationary object velocity point cloud and the moving object velocity point cloud based on the estimation results.

More specifically, the stationary object point cloud correction unit 213 and the moving object point cloud correction unit 214 correct the time information of each point included in the stationary object velocity point cloud and the moving object velocity point cloud to the reference time. This eliminates the distortion of the point cloud caused by the self-motion or the moving object motion within the frame time span, making it possible, in the embodiment, to implement more universal use of the measurement result by the FMCW-LiDAR.

The stationary object point cloud correction unit 213 and the moving object point cloud correction unit 214 individually output the corrected stationary object velocity point cloud and moving object velocity point cloud. At this time, the stationary object point cloud correction unit 213 and the moving object point cloud correction unit 214 add a timestamp indicating time (frame start time t_{fst2} in the example of FIG. 6) to be a reference of correction to the corrected stationary object velocity point cloud and moving object velocity point cloud, and output the data with the timestamp. Here, the timestamp is a value determined for each frame.

In this manner, the stationary object point cloud correction unit 213 and the moving object point cloud correction unit 214 function as a correction unit that corrects at least one attribute value related to at least one point included in the velocity point cloud data based on an estimated value at a predetermined time-point.

The stationary object point cloud correction unit 213 and the moving object point cloud correction unit 214 respectively pass the stationary object velocity point cloud and the moving object velocity point cloud, corrected and having the timestamp added, to the transmission unit 201.

A specific example of correction processing based on the sensor position, orientation, and angular velocity and the sensor velocity by the stationary object point cloud correction unit 213 and the moving object point cloud correction unit 214 will be described below.

In the embodiment, this correction processing makes it possible to treat each point included in the stationary object velocity point cloud and the moving object velocity point cloud in one frame as a point acquired at the same time-point, leading to reduction of the load of processing on the stationary object velocity point cloud and the moving object velocity point cloud in the subsequent stage.

In addition, in the embodiment, the velocity point cloud is corrected based on values estimated based on the sensor position, orientation, angular velocity, and the sensor velocity. Therefore, in the embodiment, the velocity point cloud in which each point has the time information of the same time can be acquired by the FMCW-LiDAR data for one frame.

Note that the method of acquiring the velocity point cloud in which each point has the time information of the same time-point is not limited to the above-described method. For example, by using FMCW-LiDAR data of a plurality of frames and by performing linear interpolation based on data having correspondence of the emission point 41 among the plurality of frames, it is also possible to acquire a velocity point cloud in which each point has time information of the same time-point.

### (2-1-2-2. Application Section)

Next, the application section of the signal processing unit 20 will be described.

In FIG. 2, the stationary object point cloud correction unit 213 passes the corrected stationary object velocity point cloud to the transmission unit 201 and the map converter 220.

The map converter 220 estimates and generates map information based on the sensor position, orientation, and angular velocity passed from the sensor position/orientation estimation unit 210 and the stationary object velocity point cloud passed from the stationary object point cloud correction unit 213. The map information includes the self-position of the sensor unit 10 and the map of the surrounding environment of the sensor unit 10. The map converter 220 may apply a technique of Simultaneous Localization and Mapping (SLAM) to map creation. The map converter 220 passes the generated map information to the transmission unit 201.

The moving object point cloud correction unit 214 passes the corrected moving object velocity point cloud to the transmission unit 201 and also to the moving object state estimation unit 221 and the combining unit 224.

For example, the moving object state estimation unit 221 separates each moving object included in one frame based on the corrected moving object velocity point cloud. For each separated moving object, the moving object state estimation unit 221 estimates the state of the moving object including the position, orientation, velocity, and angle of the moving object based on the corresponding moving object velocity point cloud. The moving object state estimation unit 221 passes moving object state information, being information indicating the estimated state of the moving object, to the transmission unit 201 and also passes the moving object state information to the moving object point cloud correction unit 214 and the 3D/2D transformer 222.

The 3D/2D transformer 222 transforms a moving object velocity point cloud, which is three-dimensional (3D) information, into two-dimensional (2D) data corresponding to image data output from the image sensor 120. More specifically, the 3D/2D transformer 222 transforms the 3D coordinates of the moving object velocity point cloud into 2D coordinates according to the coordinate system of the image data obtained by the image sensor 120. The 3D/2D transformer 222 preliminarily acquires calibration data such as a positional relationship of the reference coordinate system of the light detection and ranging sensor 110 with respect to the reference coordinate system of the image sensor 120 and internal parameters of each sensor in advance, and uses the prepared calibration data at the time of transformation. This makes it possible to obtain the position of each moving object indicated in the moving object velocity point cloud in the image data. The 3D/2D transformer 222 passes the point cloud, being a point cloud obtained by transforming the coordinates of the moving object velocity point cloud into 2D coordinates, to the ROI extraction unit 223.

Based on the point cloud in the 2D coordinates passed from the 3D/2D transformer 222, the ROI extraction unit 223 extracts the region of interest (ROI) from the image data passed from the image sensor 120 via the reception unit 200. More specifically, the ROI extraction unit 223 may extract, for example, a region corresponding to the point cloud in the 2D coordinates passed from the 3D/2D transformer 222 in the image data, as the region of interest. Incidentally, the positional relationship between the light detection and ranging sensor 110 and the image sensor 120 is known, the ROI extraction unit 223 can instantaneously calculate the correspondence relationship between the image data and the point cloud on the 2D coordinates.

The ROI extraction unit 223 passes the extracted image data of the region of interest to the transmission unit 201, and also to the combining unit 224 and the image perception unit 226.

The combining unit 224 combines the moving object velocity point cloud passed from the moving object point cloud correction unit 214 with the image data of the region of interest passed from the ROI extraction unit 223. For example, the combining unit 224 may combine the moving object velocity point cloud with the image data of the region of interest. In this case, the combining unit 224 may associate velocity information of each point included in the moving object velocity point cloud with each pixel data in the image data of the region of interest. The image obtained by combining the velocity information with each pixel of the image data of the region of interest is referred to as a combined image.

Combining is not limited thereto, and the combining unit 224 may combine the image data of the region of interest with the moving object velocity point cloud. In this case, the combining unit 224 may associate information of corresponding pixel data in the region of interest with each point of the moving object velocity point cloud. A point cloud obtained by combining each pixel data of the region of interest with each point of the moving object velocity point cloud is referred to as a combined point cloud.

The combining unit 224 passes the combined image or the combined point cloud to the transmission unit 201 as well as to the motion perception unit 225.

The motion perception unit 225 perceives the motion of the moving object based on the combined image or the combined point cloud passed from the combining unit 224. The motion perception unit 225 can acquire velocity distribution information based on the velocity information of each point included in the combined image or the combined point cloud. The motion perception unit 225 can more precisely estimate the motion of the moving object by using the distribution information of velocity. For example, the motion perception unit 225 may perform motion perception using a learning model trained by machine learning based on known velocity distribution information. The motion perception unit 225 perceives the motion of the moving object and outputs meta-information (walking, running, etc.) related to the motion. The motion meta-information output from the motion perception unit 225 is passed to the transmission unit 201.

The image perception unit 226 performs image perception based on the image data of the region of interest passed from the ROI extraction unit 223, and outputs image meta-information (indicating that the subject is a person, subject name, or indicating the subject is a vehicle, etc.). For example, the image perception unit 226 may perform image perception using a learning model trained by machine learning based on image data using known images. The image meta-information output from the image perception unit 226 is passed to the transmission unit 201.

The transmission unit 201 transmits the sensor position, orientation, and angular velocity passed from the sensor position/orientation estimation unit 210 and the sensor velocity passed from the sensor velocity estimation unit 212 to the information processing unit 30. In addition, the transmission unit 201 transmits the map information passed from the map converter 220 and the corrected stationary object velocity point cloud passed from the stationary object point cloud correction unit 213 to the information processing unit 30. Furthermore, the transmission unit 201 transmits the moving object velocity point cloud passed from the moving object point cloud correction unit 214 and the moving object state information passed from the moving object state estimation unit 221 to the information processing unit 30. Furthermore, the transmission unit 201 transmits the combined image or the combined point cloud passed from the combining unit 224, the ROI image passed from the ROI extraction unit 223, the motion meta-information passed from the motion perception unit 225, and the image meta-information passed from the image perception unit 226 to the information processing unit 30.

The transmission unit 201 adds a timestamp to each of the information and the point cloud described above and transmits the data with the timestamp to the information processing unit 30. Here, the timestamp added to each piece of information and the point cloud by the transmission unit 201 may be time-point information in units of one frame of scanning by the light detection and ranging sensor 110. As a specific example, with reference to FIG. 6 described above, information indicating the frame start time t_{fst2} serving as a reference of correction of the velocity point cloud may be added as a timestamp to each piece of information acquired in the period from the frame start time t_{fst1} to the next frame start time t_{fst2} in the scanning by the light detection and ranging sensor 110.

In this manner, the transmission unit 201 functions as a transmission unit that adds the corrected time-point information indicating a predetermined time-point to the attribute value corrected by the correction unit and transmits the attribute value together with the corrected time-point information.

The transmission unit 201 may selectively transmit, to the information processing unit 30, information or a point cloud in response to a request from the information processing unit 30 among the above-described information and point cloud. Furthermore, the transmission unit 201 may transmit each piece of the information and the point cloud described above to a transmission destination different from the information processing unit 30.

### (2-2-1. System Configuration)

Next, a system configuration applicable to the embodiment will be described.

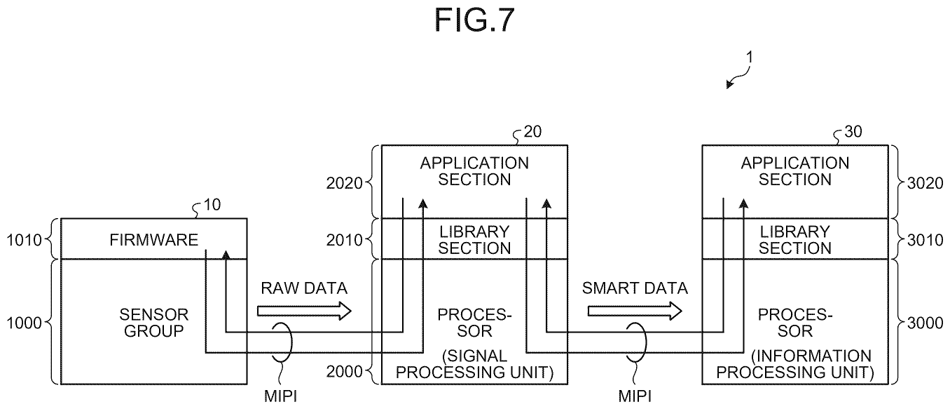

FIG. 7 is a block diagram illustrating a hardware configuration of an example of the signal processing system 1 applicable to the embodiment.

In FIG. 7, the sensor unit 10 includes a sensor group 1000 and firmware 1010. The sensor group 1000 includes an IMU 100, a light detection and ranging sensor 110, and an image sensor 120.

The firmware 1010 may be a program for controlling the operation of the sensor group 1000. The firmware 1010 may control, for example, an interface (not illustrated) as hardware that controls input/output of data of each sensor included in the sensor group 1000 and an operation of the synchronization signal generator 130. For example, the interface may include memory that stores the firmware 1010 in advance and a processor that operates according to the firmware 1010 stored in the memory.

The signal processing unit 20 includes a processor 2000. The processor 2000 operates according to a program stored in memory (not illustrated), so as to implement the above-described library section 2010 and application section 2020. The processor 2000 may be, for example, an Image Signal Processor (ISP). The processor 2000 is not limited thereto, and may be a Digital Signal Processor (DSP) or a Central Processing Unit (CPU).

Furthermore, the configuration is not limited to this configuration, and a part or all of the units included in the library section 2010 and the application section 2020 described above can be implemented by hardware circuits that operate in cooperation with each other.

Similarly to the signal processing unit 20, the information processing unit 30 includes, for example, a processor 3000 including an ISP. The processor 3000 operates according to a program stored in memory (not illustrated), so as to implement a library section 3010 and an application section 3020. The library section 3010 is a set of programs that provide individual functions in the information processing unit 30, and the application section 3020 is a set of programs that execute target processing using the functions provided by the library section 3010.

As an example, in a case where the information processing unit 30 is applied to the control of an autonomously operating robot (mobile body), the library section 3010 may include a function of outputting a control command for driving the robot. Furthermore, the application section 3020 may include a function of deciding the motion of the robot based on the map information, the motion meta-information, the image meta-information, and the like passed from the signal processing unit 20. As another example, in a case where the information processing unit 30 is applied to a control system of a monitoring camera, the library section 3010 may include a function of outputting a control command for controlling the operation of the monitoring camera. In addition, the application section 3020 may include a function of performing judgment based on an image from a monitoring camera, motion meta-information passed from the signal processing unit 20, image meta-information, and the like.

Not limited to this configuration, some or all of the units included in the library section 3010 and the application section 3020 can be implemented by hardware circuits that operate in cooperation with each other. Furthermore, a typical computer may be applied as the information processing unit 30.

In the example of FIG. 7, the output (image data, FMCW-LiDAR data, IMU data) of each sensor included in the sensor group 1000 is output as RAW data in a predetermined format under the control of the firmware 1010, and is transmitted to the signal processing unit 20 by an interface (not illustrated). The signal processing unit 20 receives the RAW data transmitted from the sensor unit 10 by the reception unit 200 and passes the RAW data to the library section 2021.

The library section 2010 performs the above-described processing on the RAW data passed from the reception unit 200 and passes the processed RAW data to the application section 2020. The application section 2020 performs the above-described processing on the data passed from the library section 2010, and the transmission unit 201 adds a timestamp in units of frames to each piece of information and a point cloud generated by the processing and outputs the data with the timestamp. In the example of FIG. 7, the output of the signal processing unit 20 is transmitted to the information processing unit 30 as SMART data.

The information processing unit 30 receives the SMART data transmitted from the signal processing unit 20 and passes the SMART data to the library section 3010.

The library section 3010 performs processing related to individual functions on the received SMART data and passes the data to the application section 3020. The application section 3020 performs predetermined processing on the data passed from the library section 3010 to generate output data. The data generated by the application section 3020 may be output from the information processing unit 30, for example.

The information processing unit 30 may generate a request for the signal processing unit 20 by the application section 3020, for example, and transmit the generated request to the signal processing unit 20. For example, the application section 3020 may generate and transmit, to the signal processing unit 20, a request for designating each piece of information that can be transmitted by the signal processing unit 20 using the transmission unit 201, necessary information from the point cloud, and the point cloud.

Similarly, the signal processing unit 20 may generate a request for the sensor unit 10 using the application section 2020, for example, and transmit the generated request to the sensor unit 10. For example, the application section 2020 may generate and transmit a request for restricting the scanning range to the region of interest to the light detection and ranging sensor 110.

In the example of FIG. 7, a Mobile Industry Processor Interface (MIPI) (registered trademark) is applied as an interface for data transmission from the sensor unit 10 to the signal processing unit 20 and data transmission from the signal processing unit 20 to the information processing unit 30. More specifically, a MIPI-Camera Serial Interface 2 (MIPI-CSI-2) may be applied as the interface.

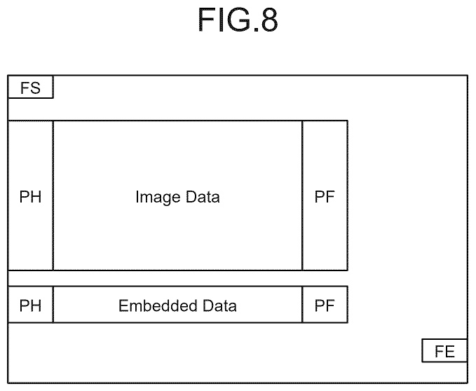

FIG. 8 is a schematic diagram illustrating an example of a data format specified in MIPI-CSI-2, applicable to the embodiment. FIG. 8 illustrates an example of transmitting image data of one frame. Here, a case of data transmission from the sensor unit 10 to the signal processing unit 20 will be described.

In FIG. 8, an upper left on the figure is a start position of data transmission. Data is transmitted in an order from left to right on the figure, and is further transmitted in an order from top to bottom on the figure. At the upper left start position, a field Frame Start (field FS) indicating the head of the frame is transmitted. At the end of the frame, a field Frame End (field FE) is transmitted.

Data transmission is started from data at the left end, and data transmission of the same row sequentially proceeds toward the right end. When the data transmission reaches the right end, the data transmission is sequentially started again from the left end data to the right end in the row immediately below in the figure. In the figure, a blank portion indicates that there is no data to be transmitted.

The field PH is a field in which a packet header is transmitted, and the field PF is a field in which a packet footer is transmitted. A field Image Data is a field in which image data is transmitted. The image data of the field Image Data is interposed between the field PH and the field PF for each row and sequentially transmitted from the left side toward the right side. The image data output from the image sensor 120 may be transmitted by the field Image Data.

The field Embedded Data is a field used to transmit data other than image data. For example, in a case where optional data is defined, the data is generally transmitted by the field Embedded Data.

Similarly to the image data, the data of the field Embedded Data is interposed between the field PH and the field PF and sequentially transmitted from the left side toward the right side. The IMU data output from the IMU 100 of the sensor unit 10 may be transmitted by the field Embedded Data. Information indicating a type of data (IMU data or the like) transmitted by the field Embedded Data may be transmitted by the field PH.

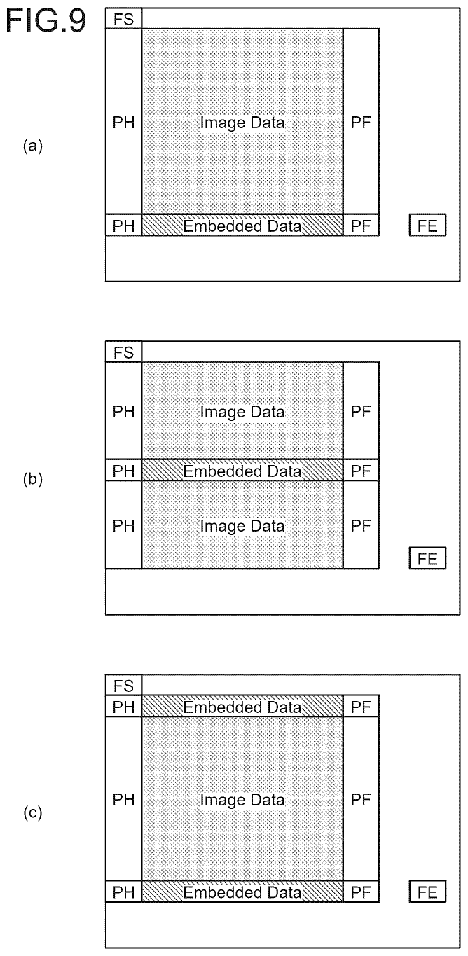

In the example of FIG. 8, the field Embedded Data is transmitted after the field Image Data, but the order is not limited to this example. FIG. 9 is a schematic diagram illustrating another example of a data format specified in MIPI-CSI-2, applicable to the embodiment.

In FIG. 9, a section (a) is an example in which the field Embedded Data is transmitted after the field Image Data, similarly to FIG. 8. Section (b) is an example in which the transmission of the field Image Data is temporarily interrupted and the field Embedded Data is transmitted in the middle of transmission of the field Image Data. Furthermore, section (c) is an example in which the field Embedded Data is transmitted before and after the field Image Data. Furthermore, the field Embedded Data may be transmitted before the field Image Data.

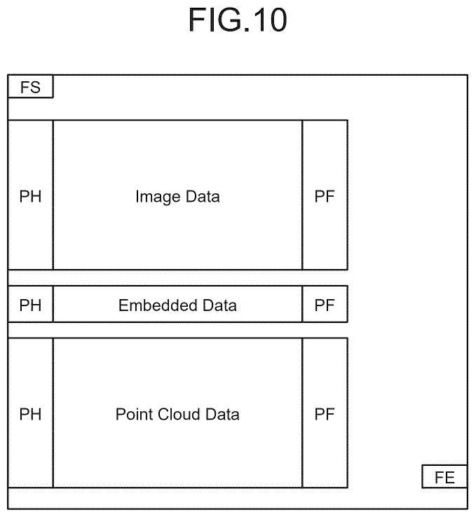

In addition, a point cloud may be transmitted in the frame of the MIPI. FIG. 10 is a schematic diagram illustrating an example of transmission of a point cloud using a data format specified in MIPI-CSI-2, applicable to the embodiment.

In the example of FIG. 10, after transmission of the field Image Data sandwiched between the fields PH and PF, the field Embedded Data is similarly transmitted in a state sandwiched between the fields PH and PF. In the field Embedded Data, IMU data is transmitted, for example. Furthermore, after the field Embedded Data, the point cloud data, sandwiched between the fields PH and PF, is transmitted in a field Point Cloud Data. After the field Point Cloud Data, a field FE indicating the end of the frame is transmitted.

In the above description, the field Image Data, the field Embedded Data, and the field Point Cloud Data are transmitted in this order, but the transmission order of each data is not limited to this example. In addition, the field Image Data or the field Point Cloud Data may be divided and transmitted in one frame.

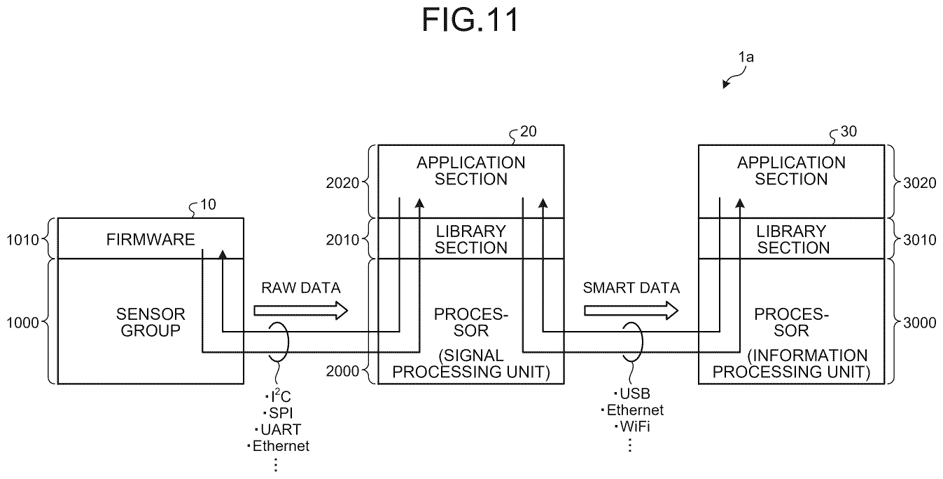

Although the above has described an example in which an interface related to data transmission between the sensor unit 10 and the signal processing unit 20 and between the signal processing unit 20 and the information processing unit 30 is the MIPI, the interface is not limited to this example. In the embodiment, another interface may be applied as the interface related to the data transmissions. For example, as in a signal processing system 1a illustrated in FIG. 11, the interface between the sensor unit 10 and the signal processing unit 20 may be implemented by applying a serial interface mainly used for device internal data communication, such as an inter-integrated circuit (I²C), a Serial Peripheral Interface (SPI), or a Universal Asynchronous Receiver/Transmitter (UART), or a communication interface such as a Universal Serial Bus (USB) or Ethernet (registered trademark). Furthermore, the interface between the signal processing unit 20a and the information processing unit 30 may be implemented by applying an interface mainly used for device external communication, such as USB, Ethernet, or Wireless Fidelity (Wi-Fi) (registered trademark).

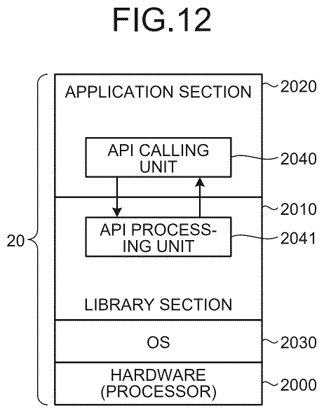

FIG. 12 is a diagram illustrating an example of an architecture of the signal processing unit 20 according to the embodiment. The signal processing unit 20 has a structure in which an operating system (OS) 2030 operates on a processor 2000 such as an ISP being a hardware component, and the library section 2010 and the application section 2020 operate on the OS 2030.

The application section 2020 includes an Application Programming Interface (API) calling unit 2040, while the library section 2010 includes an API processing unit 2041. The API calling unit 2040 calls a function of the library section 2010 in response to a request from the application section 2020. In response to the function call by the API calling unit 2040, the API processing unit 2041 returns a response by the function in the library section 2010 to the API calling unit 2040.

As an example, in a case where, in the application section 2020, the moving object state estimation unit 221 requests output of the moving object state information, the API calling unit 2040 requests the moving object velocity point cloud from the library section 2010. In response to this request, the API processing unit 2041 calls, in the library section 2010, the function of the moving object point cloud correction unit 214 and returns the moving object velocity point cloud output from the moving object point cloud correction unit 214 to the API calling unit 2040. The API calling unit 2040 passes the moving object velocity point cloud returned from the API processing unit 2041 to the moving object state estimation unit 221.

### (2-2. Processing According to Embodiment)

Next, the processing according to the embodiment will be described in more detail.

### (2-2-1. Measurement Technique Applicable to Embodiment)

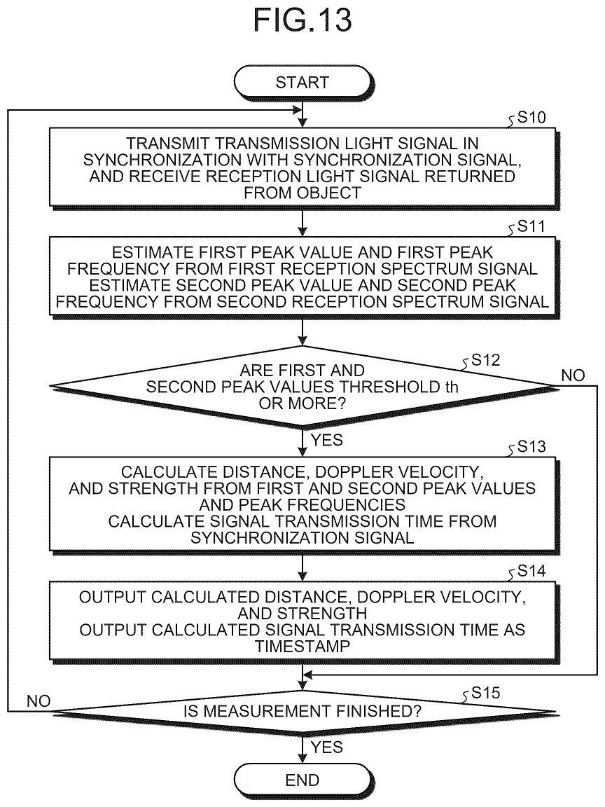

FIG. 13 is a flowchart of an example illustrating transmission light signal detection processing in the light detection and ranging sensor 110, applicable to the embodiment.

In step S10, the light detection and ranging sensor 110 uses the light transmission/reception unit 112 to transmit (emit) a transmission light signal of laser light subjected to continuous frequency modulation in synchronization with a synchronization signal, and receives a reception light signal reflected on and returned from an object.

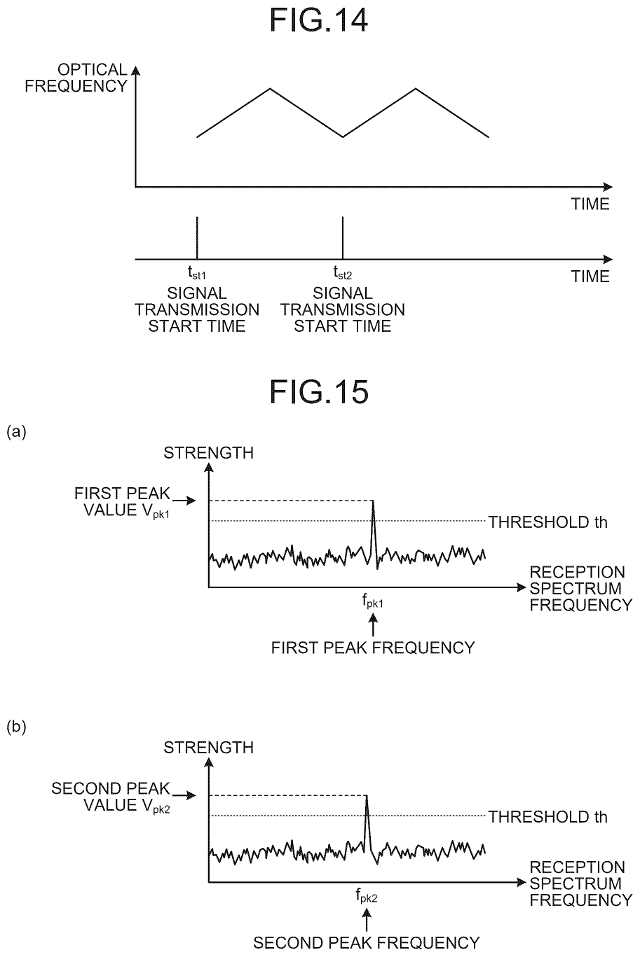

FIG. 14 is a schematic diagram for illustrating a transmission light signal transmitted by the light transmission/reception unit 112, applicable to the embodiment. The upper diagram of FIG. 14 illustrates the relationship between the optical frequency of the transmission light signal and the time, while the lower diagram illustrates signal transmission start time tst in the upper diagram. In the upper diagram of FIG. 14, the vertical axis represents the optical frequency of the transmission light signal, and the horizontal axis represents time.

In FIG. 14, for example, the light transmission/reception unit 112 linearly increases and decreases the optical frequency of the laser light using a period from the signal transmission start time tₛₜ₁ to the next signal transmission start time tₛₜ₂, and generates chirp light. The light transmission/reception unit 112 emits, as a transmission light signal, chirp light formed with a set of increasing and decreasing patterns of the optical frequency from the optical scan unit 111 toward a predetermined emission point. Similarly, at the signal transmission start time tₛₜ₂, the optical frequency of the transmission light signal is linearly raised and lowered according to the above-described period to generate chirp light, and the generated chirp light is emitted from the optical scan unit 111 toward a predetermined emission point as the transmission light signal. In the raster scan pattern, the transmission light signal is formed in this manner with continuously transmitted chirped light having a set of increasing and decreasing patterns of optical frequency.

Returning to FIG. 13, in the next step S11, the light detection and ranging sensor 110 uses the reception signal processing unit 113 to estimate a first peak value and a signal spectrum frequency (peak frequency) at the peak value from a first reception spectrum signal in the received reception light signal. In addition, the light detection and ranging sensor 110 uses the reception signal processing unit 113 to estimate a second peak value and a signal spectrum frequency (peak frequency) at the peak value from a second reception spectrum signal in the received reception light signal.

The first reception spectrum signal is a signal, being a partial signal out of the reception light signal, corresponding to the transmission light signal in the period in which the optical frequency increases. The second reception spectrum signal is a signal, being a partial signal out of the reception light signal, corresponding to the transmission light signal in the period in which the optical frequency decreases.

In step S12, the reception signal processing unit 113 of the light detection and ranging sensor 110 determines whether the first peak value and the second peak value estimated in step S11 are a threshold th or more.

FIG. 15 is a schematic diagram for illustrating determination processing on a reception light signal according to the embodiment. In FIG. 15, section (a) is a diagram illustrating determination processing on the first reception spectrum signal, and section (b) is a diagram illustrating determination processing on the second reception spectrum signal. In the drawings in the sections (a) and (b), the vertical axis represents the strength of the reception light signal, and the horizontal axis represents the reception spectrum frequency.

In section (a) of FIG. 15, the strength of the first reception spectrum signal exceeds the threshold th at the signal spectrum frequency fₚₖ₁, and a first peak value Vₚₖ₁ is obtained. The signal spectrum frequency fₚₖ₁ at which the strength of the first reception spectrum signal indicates the first peak value Vₚₖ₁ is set as a first peak frequency.

Similarly, in section (b) of FIG. 15, the strength of the second reception spectrum signal exceeds the threshold th at a signal spectrum frequency fₚₖ₂, and a second peak value Vₚₖ₂ is obtained. The signal spectrum frequency fₚₖ₂ at which the strength of the second reception spectrum signal indicates the second peak value Vₚₖ₂ is set as a second peak frequency.

Returning to the description of FIG. 13. In step S12, in a case where the reception signal processing unit 113 has determined that at least one of the first peak value Vₚₖ₁ and the second peak value Vₚₖ₂ is less than the threshold th (step S12, “No”), the processing proceeds to step S15. In contrast, when having determined that each of the first peak value Vₚₖ₁ and the second peak value Vₚₖ₂ is the threshold th or more (step S12, “Yes”), the reception signal processing unit 113 proceeds to the processing to step S13.

In step S13, based on the first peak value Vₚₖ₁ and the second peak value Vₚₖ₂ and the signal spectrum frequencies fₚₖ₁ and fₚₖ₂ having the first peak value Vₚₖ₁ and the second peak value Vₚₖ₂, the reception signal processing unit 113 calculates a distance to the object, the Doppler velocity with respect to the object, and the strength of the reception light signal. In addition, the reception signal processing unit 113 calculates a signal transmission start time tₛₜ₁ based on the synchronization signal.

The emission point 41 corresponding to the reception light signal in which each of the first peak value Vₚₖ₁ and the second peak value Vₚₖ₂ is the threshold th or more is set as a detection point at which the object has been detected.

In the next step S14, the reception signal processing unit 113 outputs the distance, the Doppler velocity, and the strength calculated in step S13. In addition, the reception signal processing unit 113 outputs the signal transmission start time calculated in step S13 as a type stamp for each measurement (for each emission point).

The transmission unit 115 receives the distance, the Doppler velocity, the strength, and the timestamp, being data output from the reception signal processing unit 113. The transmission unit 115 adds a timestamp to the received distance, Doppler velocity, and strength, and outputs the data with the timestamp as FMCW-LiDAR data from the light detection and ranging sensor 110.

In the next step S15, the light detection and ranging sensor 110 determines whether the measurement has been completed. For example, the light detection and ranging sensor 110 may determine whether the measurement has been finished in accordance with a control signal (not illustrated) input from the outside to the sensor unit 10. When having determined that the measurement is finished, the light detection and ranging sensor 110 finishes a series of processing according to the flowchart of FIG. 14.

In contrast, when having determined in step S15 that the measurement has not been finished, the light detection and ranging sensor 110 returns the processing to step S10 and executes processing for the next emission point.

The determination processing in step S12 in the flowchart of FIG. 13 will be described using a specific example.

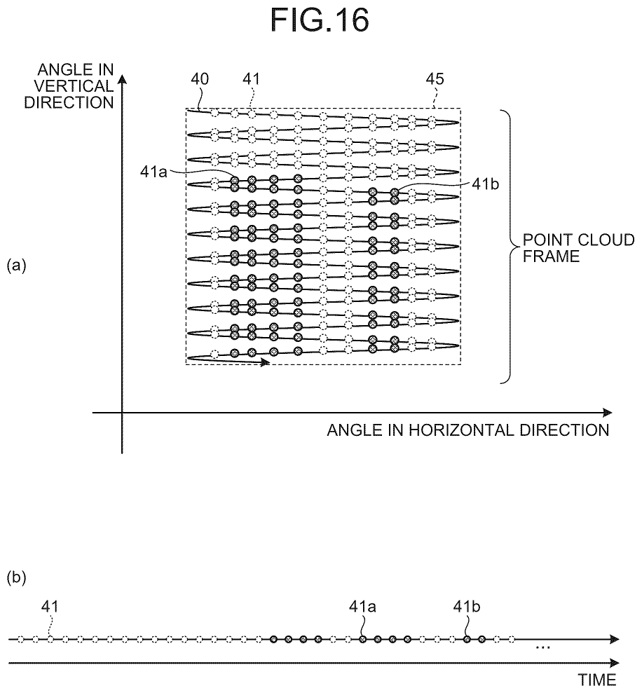

FIG. 16 is a schematic diagram illustrating an example of data output in a case where the light detection and ranging sensor 110 according to the embodiment performs scanning with a raster scan pattern. In FIG. 16, section (a) corresponds to FIG. 4 described above, and the vertical axis indicates the angle in the vertical direction of scanning and the horizontal axis indicates the angle in the horizontal direction of scanning. Section (b) illustrates an example in which the FMCW-LiDAR data output from the light detection and ranging sensor 110 corresponding to each emission point 41 is arranged in time series. Furthermore, the emission points 41a and 41b illustrated in the figure as solid points are, for example, emission points corresponding to positions where the objects 50a and 50b (refer to FIG. 4) exist, and reflected light, that is, the light reflected by the objects 50a and 50b is returned as a reception light signal.

The light detection and ranging sensor 110 uses the optical scan unit 111 to scan between the upper end and the lower end of the angular range 45 according to the scanning line 40 folded, within a predetermined angular range 45, at both ends in the horizontal direction of the angular range 45. Each of the emission points 41, 41a, and 41b within the angular range 45 constitutes a point cloud frame.

As illustrated in section (b) of FIG. 16, the output data of each emission point 41 is output at predetermined time intervals, for example, in accordance with the emission timing of the transmission light signal. In this case, the emission points 41 (indicated by dotted circles in the figure) other than the emission points 41a and 41b corresponding to the positions where the objects 50a and 50b exist can be considered as points where there is no reception, in the light detection and ranging sensor 110, of light signal corresponding to the transmission light signal, or the reception light signal that has been received is noise.

Referring to FIG. 15, for example, at the emission points 41a and 41b, the first peak value Vₚₖ₁ and the second peak value Vₚₖ₂ at which the strength of the reception light signal is the threshold th or more are obtained. Therefore, according to the determination in step S12 in the flowchart of FIG. 13 (step S12, “Yes”), the processing proceeds to step S13.

On the other hand, at the emission point 41 indicated by a dotted circle in FIG. 16, at least one of the first peak value Vₚₖ₁ and the second peak value Vₚₖ₂ of the strength is not clearly obtained or is a value less than the threshold th. Therefore, according to the determination in step S12 in the flowchart of FIG. 13 (step S12, “No”), the processing proceeds to step S15.

In this manner, the processing of steps S13 and S14 in the flowchart of FIG. 13 is executed at the emission points 41a and 41b corresponding to the positions where the objects 50a and 50b exist, among the emission points included in the point cloud frame. On the other hand, at the emission points 41 indicated by dotted circles in the figure other than the emission points 41a and 41b, among the emission points included in the point cloud frame, the processing of steps S13 and S14 is canceled, and the processing for the next emission point is executed.

### (2-2-2. Example of Data Structure According to Embodiment)

Next, a data structure example according to the embodiment will be described. The following will describe, in particular, a data structure example regarding each data transmitted from the sensor unit 10 to the signal processing unit 20.

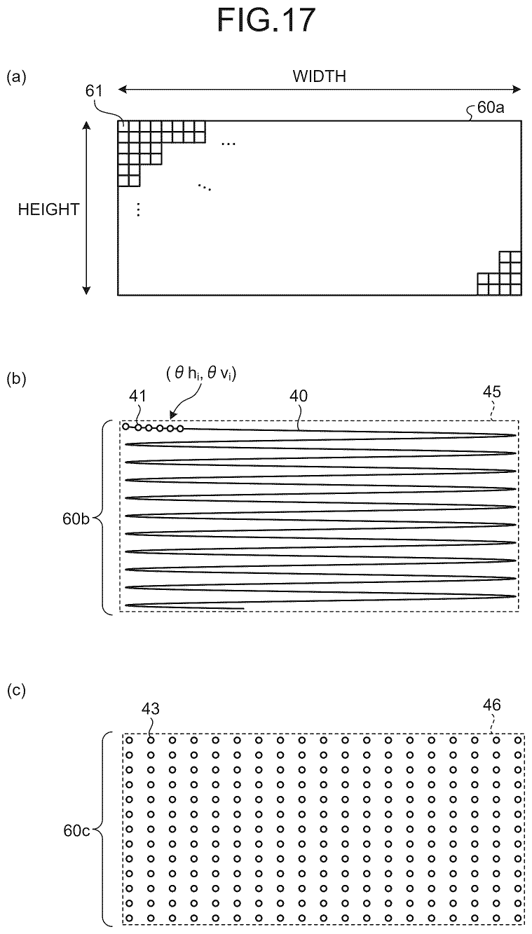

FIG. 17 is a schematic diagram for illustrating a frame definition applicable to the embodiment. In FIG. 17, section (a) illustrates an example of a frame based on image data output from the image sensor 120. Sections (b) and (c) of FIG. 17 each illustrate an example of a frame based on the FMCW-LiDAR data output from the light detection and ranging sensor 110. Here, section (b) illustrates an example of a raster scan pattern used in raster scan, and section (c) illustrates an example of a dot scan pattern used in dot scan.

The raster scan is implemented by a mechanical mirror scanner, for example. The dot scan is implemented by, for example, a beam steering device such as an optical phase array (OPA) or a light beam switching element.

In the image data illustrated in section (a) of FIG. 17, a set of pixels 61 including information of respective colors of red (R), green (G), and blue (B) constitutes a frame 60a. The size of the frame 60a is represented by the number of pixels 61 in the width direction and the height direction. Each pixel 61 is arranged in a matrix array corresponding to each pixel included in the effective pixel region of the pixel array.

In the FMCW-LiDAR data according to the raster scan pattern illustrated in section (b) of FIG. 17, the emission points 41 within the predetermined angular range 45 constitute a frame (point cloud frame) 60b. In the raster scan pattern, as described above, scanning is performed according to the scanning line 40 folded back at both ends in the horizontal direction of the angular range 45. The position of each emission point 41 on the scanning line 40 is represented by the scanning angles (horizontal angle θhᵢ, vertical angle θvᵢ) in the horizontal and vertical directions of the transmission light signal from the optical scan unit 111.

In the raster scan pattern, as described above, chirp light by a set of rise and fall of the optical frequency is continuously transmitted, forming a transmission light signal. Each emission point 41 illustrated in section (b) of FIG. 17 may be defined corresponding to, for example, a scanning angle (horizontal angle θhᵢ and vertical angle θvᵢ) at signal transmission start time-points tₛₜ₁, tₛₜ₂, . . . at which the optical frequency starts to rise in the chirp light.

In the FMCW-LiDAR data according to the dot scan pattern illustrated in section (c) of FIG. 17, the individual emission points 43 within a predetermined scanning range 46 constitute a frame (point cloud frame) 60c. In the dot scan pattern, the chirp light is completed for each emission point 43. That is, the transmission light signal is transmitted for each emission point 43. Therefore, the position of each emission point 43 may be represented by an xy coordinate in the scanning range 46.

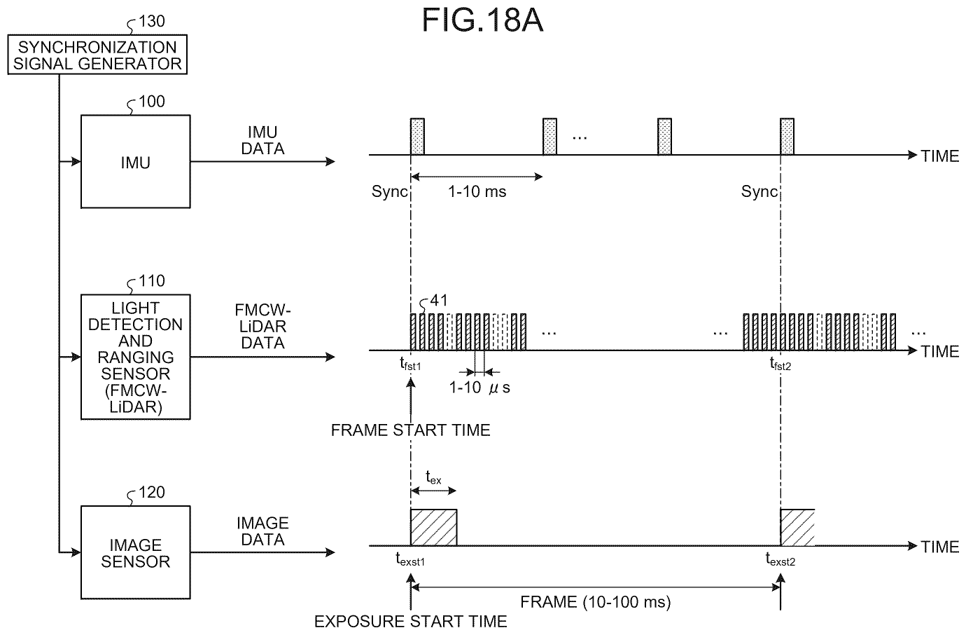

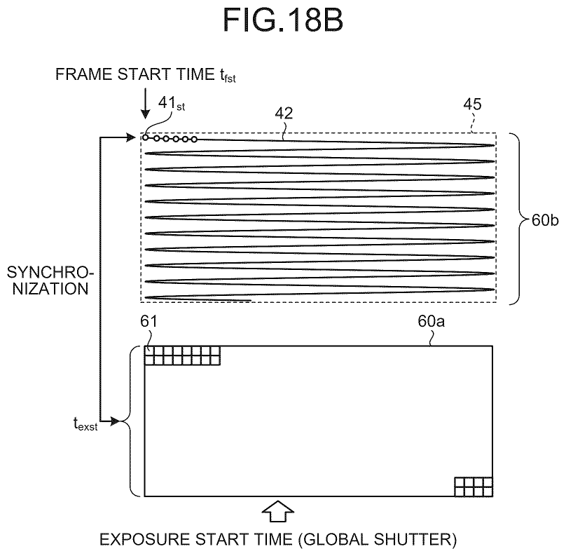

FIGS. 18A and 18B are schematic diagrams for illustrating output timing of each data by the sensor unit 10 according to the embodiment. Here, it is assumed that the image sensor 120 performs exposure by a global shutter system that simultaneously exposes all pixels.

FIG. 18A illustrates an example of measurement timing by each sensor of the sensor unit 10 according to the embodiment. In the sensor unit 10, the IMU 100, the light detection and ranging sensor 110, and the image sensor 120 each perform a measurement operation in synchronization with a synchronization signal Sync supplied from the synchronization signal generator 130, and outputs data. Note that the synchronization signal Sync is supposed to be output from the synchronization signal generator 130 in a period corresponding to one frame period of image data.

The image sensor 120 starts exposure at the exposure start time tₑₓₛₜ₁ in synchronization with the synchronization signal Sync, and continues exposure during an exposure period tₑₓ. At an exposure start time tₑₓₛₜ₂ after one frame period of the image data, exposure of the next one frame is started. The frame period of the image data is about 10 ms (milliseconds) to 100 ms. For example, image data of one frame by exposure started from the exposure start time tₑₓₛₜ₁ is output during a period from the end of the exposure period tₑₓ to the next exposure start time tₑₓₛₜ₂.

In accordance with the synchronization signal Sync, the light detection and ranging sensor 110 starts scanning of one frame at each point of frame start time t_{fst1}, t_{fst2}, . . . synchronized with the points of exposure start time tₑₓₛₜ₁, tₑₓₛₜ₂, . . . for example. FIG. 18B schematically illustrates a relationship between the exposure start time tₑₓₛₜ in the image sensor 120 and the frame start time t_{fst} in the light detection and ranging sensor 110. As illustrated in FIG. 18B, the emission timing of the transmission light signal at an emission point 41ₛₜ at the head of the frame 60b by the light detection and ranging sensor 110 is synchronized with the exposure start time tₑₓₛₜ of each pixel 61 in the frame 60a by the image sensor 120.

In the light detection and ranging sensor 110, the emission interval of the transmission light signal at each emission point 41 is set to about 1 μs (microsecond) to several 100 μs, for example. The FMCW-LiDAR data is output in accordance with the emission timing of each emission point 41.

Here, the emission point 41 illustrated with a dotted line in the drawing indicates an emission point at which the transmission light signal has not been reflected by an object or the like and thus the reception light signal has not been received, or an emission point at which the strength of the reception light signal is less than the threshold th, for example. In addition, an emission point 41 illustrated with a solid line (hatched) in the drawing indicates, for example, an emission point at which a transmission light signal has been reflected by an object or the like and thus a reception light signal having an intensity being the threshold th or more has been received. Accordingly, the FMCW-LiDAR data is actually output only at the timing corresponding to the emission point 41 illustrated with the hatched solid line in the figure.

The IMU 100 outputs the IMU data in synchronization with the head of the frame of the image data and the FMCW-LiDAR data in accordance with the synchronization signal Sync. The IMU 100 may output the IMU data according to, for example, a signal obtained by multiplying the synchronization signal Sync in a period from the synchronization signal Sync to the next synchronization signal Sync. The output interval of the IMU data in the IMU 100 is set to about 1 ms to 1000 ms, for example.

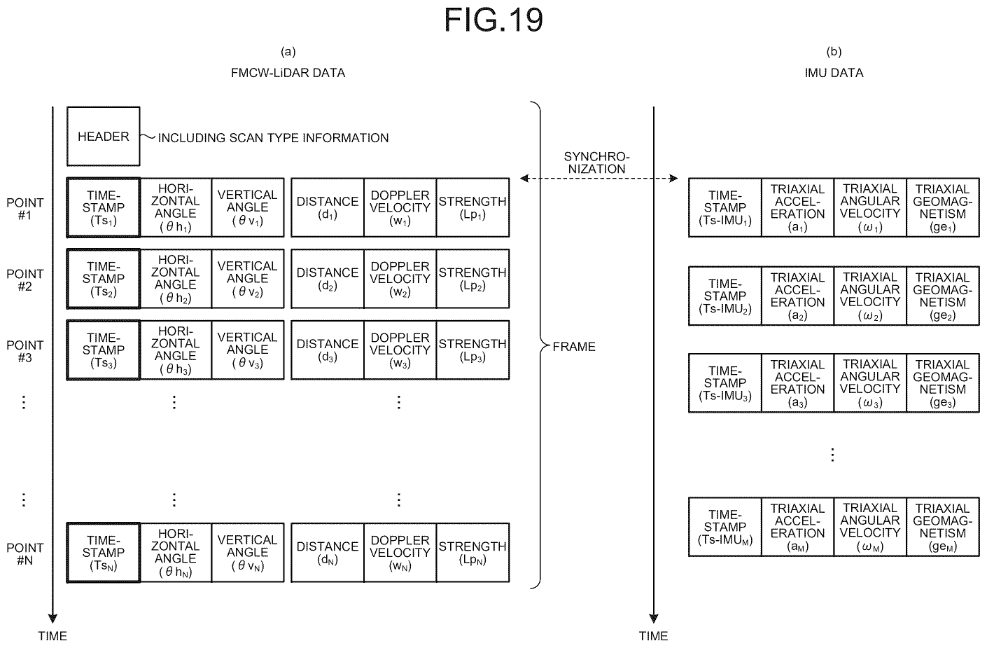

FIG. 19 is a schematic diagram illustrating an example of a data structure of FMCW-LiDAR data and IMU data output from the sensor unit 10 according to the embodiment. In FIG. 19, a section (a) illustrates an example of a data structure of FMCW-LiDAR data, and a section (b) illustrates an example of a data structure of IMU data. In both sections (a) and (b), time is represented in the vertical direction on the figure.

In section (a) of FIG. 19, in the FMCW-LiDAR data, for example, a header is transmitted at the head of the frame, and then, data corresponding to each emission point is sequentially transmitted following the header. Note that, in the figure, each emission point is indicated as point #1, point #2, . . . , and point #N. Hereinafter, each emission point is described as point #1, point #2, . . . , and point #N as appropriate. In addition, in a case where it is not necessary to particularly distinguish point #1, point #2, . . . , to point #N, the description will be represented by point #i, with each number using the subscript in the figure also represented by i (similar applies to section (b)).

The header includes at least scan type information. The scan type information may be information indicating a scanning method such as raster scanning, multi-layer scanning, or dot scanning.

The data of point #i includes a timestamp Tsᵢ and a scanning angle (horizontal angle θhᵢ and vertical angle θvᵢ) as information related to scanning, and includes a distance dᵢ, a Doppler velocity wᵢ, and strength Lpᵢ as measurement data obtained based on the reception light signal. The timestamp Tsᵢ indicates the time at which the transmission light signal is transmitted at the point #i.

In addition, each point #i may be a point at which the strength of the reception light signal described above has increased to the threshold th or more in the first and second reception spectrum signals. In the embodiment, since the timestamp Tsᵢ is added to the data of each point #i, it is possible to easily grasp the basis of the data of each point i included in the FMCW-LiDAR data of one frame, that is, which emission point the data as a basis of the reception light signal corresponds to.

Furthermore, there are cases where processing in the signal processing unit 20 for the data of each point #i (for example, correction processing by the stationary object point cloud correction unit 213 and the moving object point cloud correction unit 214) differ depending on the scanning method. In the embodiment, the header transmitted at the head of the frame includes scan type information indicating the scanning method. This makes it possible for the signal processing unit 20 to perform processing according to the scanning method on the FMCW-LiDAR data.

In section (b) of FIG. 19, in the IMU data, a timestamp Ts-IMUᵢ, a triaxial acceleration ai, a triaxial angular velocity ωi, and a triaxial geomagnetism geᵢ are sequentially transmitted at each measurement timing in the IMU 100. In the IMU data, the first data of the frame to which the timestamp Ts-IMUᵢ is added is synchronized with, for example, the data of the first point #1 in the FMCW-LiDAR data illustrated in section (a).

Here, the IMU 100 performs measurement at constant time intervals. Therefore, for example, by synchronizing the first data of the frame with the data of the point #1 of the FMCW-LiDAR data, it is possible to estimate the measurement timing of each data and omit each timestamp Ts-IMUᵢ.

### (2-2-3. Point Cloud Correction Processing According to Embodiment)

Next, the point cloud correction processing according to the embodiment will be described. The point cloud correction processing according to the embodiment is executed by the stationary object point cloud correction unit 213 and the moving object point cloud correction unit 214 illustrated in FIG. 2.

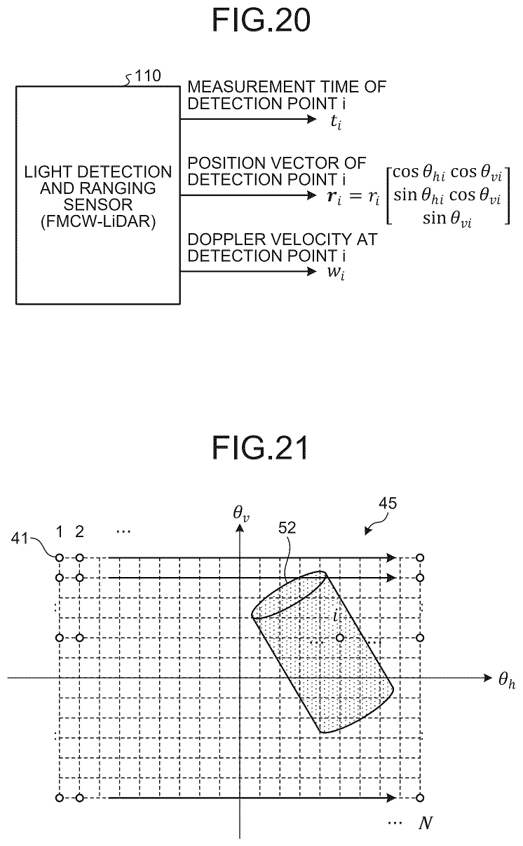

FIG. 20 is a schematic diagram illustrating an example of output data by the light detection and ranging sensor 110 according to the embodiment. The light detection and ranging sensor 110 outputs a detection time ti of a point i being the detection point i, a position vector rᵢ of the detection point i, and a Doppler velocity wᵢ of the point i. In the following description, the point i denotes an emission point at which the strength of each of the first and second reception spectrum signals in the reception light signal is the threshold th or more.

FIG. 21 is a schematic diagram illustrating a definition of coordinates of an emission point, applicable to the embodiment. In FIG. 21, when the center of the angular range 45 related to scanning is set as the origin, a vertical angle θᵥ is defined in the vertical direction and a horizontal angle θₕ is defined in the horizontal direction in the figure. When the emission point 41 at the upper left corner of the angular range 45 is set as point #1, points are set such as points #1, #2, . . . from left to right, so as to reach the emission point 41 at the lower right corner of the angular range 45 set as point #N. Among the emission points 41, the emission point 41 at a position corresponding to an object 52, being a measurement target, is set as the point i.

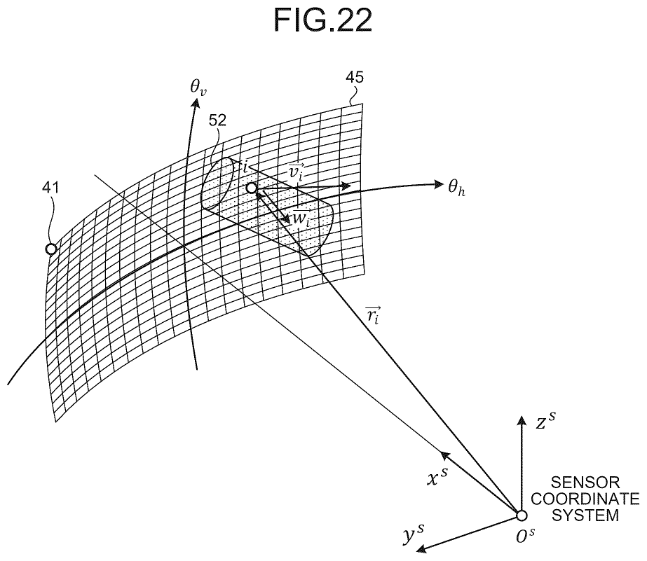

FIG. 22 is a schematic diagram illustrating each emission point 41 and the object 52 as viewed from the light detection and ranging sensor 110.

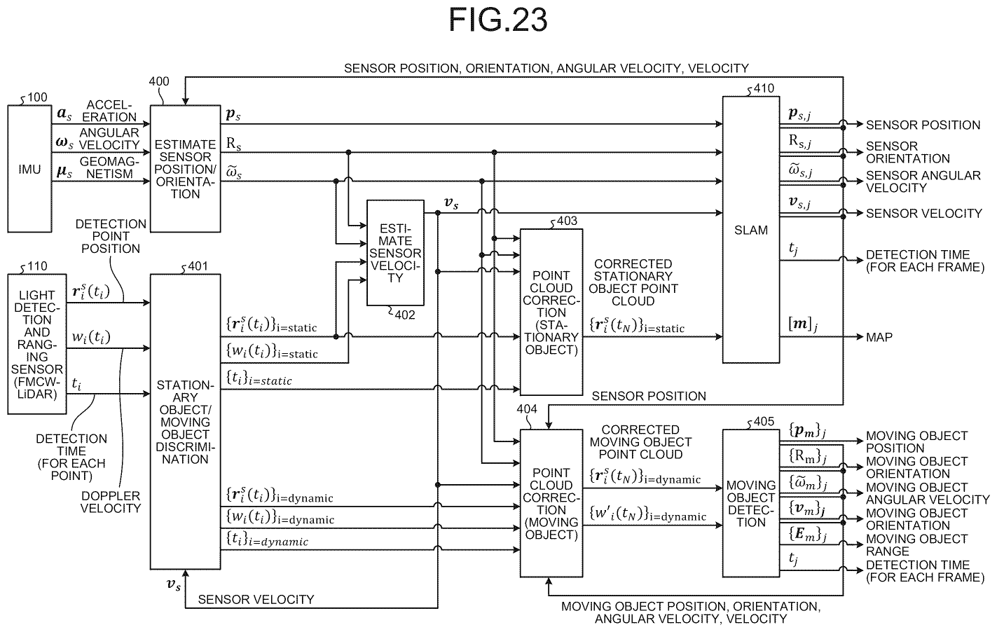

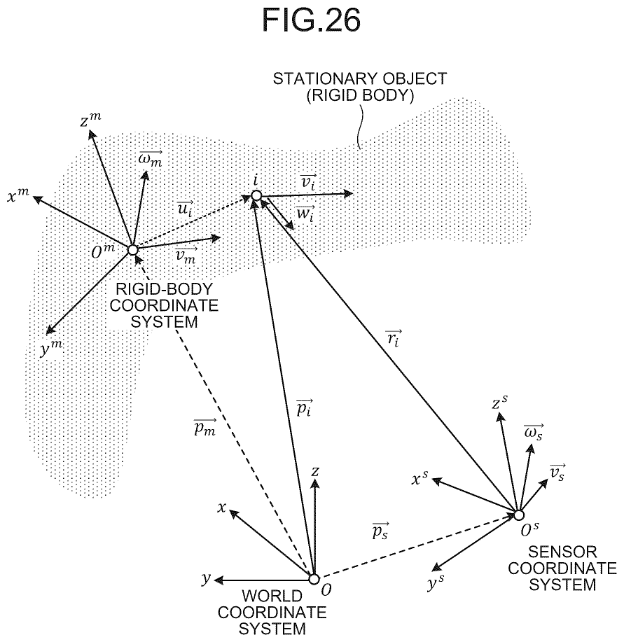

Symbols and the like used in FIG. 22 as well as FIGS. 23 and 26 to be described below, and each mathematical expression to be described below may be replaced with the following mathematical expressions.
Vectors represented in bold in the drawings and the mathematical expressions are denoted with an immediately preceding “_” (underscore), such as “Vector_x”.
In the drawings and the mathematical expressions, a character having “->” (arrow) added immediately above it to indicate a vector is denoted by adding “->” (arrow) immediately before the character, such as “vector->x”.
In the drawings and the mathematical expressions, a superscript “s” attached to a character indicates that a value represented by the character is a value in the sensor coordinate system.
In the drawings and the mathematical expressions, a superscript “m” attached to a character indicates that a value denoted by the character is a value in a moving-object/rigid-body coordinate system.
In the drawings and the mathematical formulas, a character with “·” (dot) added immediately above it to indicate time derivative is denoted by adding “·” immediately before the character, such as “·x”.
In the drawings and the mathematical formulas, a character having “˜” (tilde) added immediately above it to indicate an angular velocity tilde matrix is denoted by adding “˜” immediately before the character, such as “˜x”.

In FIG. 22, when the position of the light detection and ranging sensor 110 is set by a position O^{s} and this position O^{s} is set as an origin, a sensor coordinate system is defined by coordinate axes x^{s}, y^{s}, and z^{s}. Furthermore, for convenience, each emission point 41 is illustrated as a point equidistant from the light detection and ranging sensor 110.

In FIG. 22, at the point i corresponding to the object 52, the vector->vᵢ denotes the motion of the object 52, and the vector->wᵢ denotes the Doppler velocity of the object 52 with respect to the position O^{s} of the sensor. A vector->rᵢ starting from the position O^{s} toward the point i denotes a distance from the light detection and ranging sensor 110 to the point i in the object 52. The final target information to be acquired is vector->vᵢ.

FIG. 23 is a schematic diagram illustrating an overall flow of processing related to point cloud correction in the signal processing unit 20 according to the embodiment.

In FIG. 23, a sensor position/orientation estimation processing 400, a stationary object/moving object discrimination processing 401, and a sensor velocity estimation processing 402 are a series of processing respectively performed by the sensor position/orientation estimation unit 210, the moving object/stationary object separation unit 211, and the sensor velocity estimation unit 212 in FIG. 2. Furthermore, a point cloud correction processing 403 and 404 are processing respectively performed by the stationary object point cloud correction unit 213 and the moving object point cloud correction unit 214 in FIG. 2. Furthermore, moving object detection processing 405 is processing performed by the moving object state estimation unit 221 in FIG. 2. Note that the processing of the map converter 220 in FIG. 2 is illustrated as SLAM processing 410 in FIG. 23.

The IMU 100 outputs acceleration _aₛ, angular velocity _ωₛ, and geomagnetism _μₛ as IMU data. Based on the acceleration _aₛ, the angular velocity _ωₛ, and the geomagnetism _μₛ output from the IMU 100, and the sensor position _p_{s,j}, the sensor orientation R_{s,j}, the sensor angular velocity ˜ω_{s,j}, and the sensor velocity _v_{s,j} obtained by the SLAM processing 410, the sensor position/orientation estimation processing 400 estimates the sensor position _pₛ, the sensor orientation Rₛ, and the sensor angular velocity ˜ωₛ. The sensor position/orientation estimation processing 400 passes the estimated sensor position pₛ to the SLAM processing 410. Furthermore, the sensor position/orientation estimation processing 400 passes the estimated sensor orientation Rₛ and sensor angular velocity ˜ωₛ to the sensor velocity estimation processing 402.

The light detection and ranging sensor 110 outputs, as FMCW-LiDAR data, a detection time ti, a distance _r^{s}ᵢ(tᵢ) for a position at the detection time ti, and a Doppler velocity wᵢ(tᵢ) for each point i. Each piece of data output from the light detection and ranging sensor 110 is passed to the stationary object/moving object discrimination processing 401.

Based on each data passed from the light detection and ranging sensor 110 and the sensor velocity Vs estimated by the sensor velocity estimation processing 402, the stationary object/moving object discrimination processing 401 calculates a distance {_r^{s}ᵢ(tᵢ)}_{i=static} for the position of the stationary object at the detection time ti, the Doppler velocity {wᵢ(tᵢ)}_{i=static}, and the stationary object detection time {tᵢ}_{i=static}.

The braces “{” and “}” indicate that the sandwiched part is a set.

The stationary object/moving object discrimination processing 401 passes the calculated distance {_r^{s}ᵢ(tᵢ)}_{i=static} and the Doppler velocity {wᵢ(tᵢ)}_{i=static} to the sensor velocity estimation processing 402. In addition, the stationary object/moving object discrimination processing 401 passes the calculated distance {_r^{s}ᵢ(tᵢ)}_{i=static} and the stationary object detection time {(tᵢ)}_{i=static} to the point cloud correction processing 403 that corrects the stationary object point cloud.

Furthermore, based on each data passed from the light detection and ranging sensor 110 and the sensor velocity _vₛ estimated by the sensor velocity estimation processing 402, the stationary object/moving object discrimination processing 401 calculates a distance {_r^{s}ᵢ(tᵢ)}_{i=dynamic} for the position of the moving object at the detection time tᵢ, the Doppler velocity {wᵢ(tᵢ)}_{i=dynamic}, and the stationary object detection time {tᵢ}_{i=dynamic}.

The stationary object/moving object discrimination processing 401 passes the calculated distance {_r^{s}ᵢ(tᵢ)}_{i=dynamic}, the Doppler velocity {wᵢ(tᵢ)}_{i=dynamic}, and the stationary object detection time {tᵢ}_{i=dynamic} to the point cloud correction processing 404 that corrects the moving object point cloud.

The sensor velocity estimation processing 402 calculates the sensor velocity _vₛ as the velocity of the sensor unit 10 based on the sensor orientation Rₛ and the sensor angular velocity ˜ωₛ passed from the sensor position/orientation estimation processing 400 described above, and the distance {_t^{s}ᵢ(tᵢ)}_{i=static} and the Doppler velocity {wᵢ(tᵢ)}_{i=static} passed from the stationary object/moving object discrimination processing 401. The sensor velocity estimation processing 402 passes the calculated sensor velocity _vₛ to the stationary object/moving object discrimination processing 401, the point cloud correction processing 403 and 404, and the SLAM processing 410.

Based on the sensor orientation Rₛ and the sensor angular velocity ˜ωₛ passed from the sensor position/orientation estimation processing 400, and the distance {_r^{s}ᵢ(tᵢ)}_{i=static} and the stationary object detection time {tᵢ}_{i=static} passed from the stationary object/moving object discrimination processing 401, the point cloud correction processing 403 calculates a distance {_r^{s}ᵢ(t_{N})}_{i=static} as a corrected position of the stationary object point cloud. The point cloud correction processing 403 passes the calculated distance {_r^{s}ᵢ(t_{N})}_{i=static} to the SLAM processing 410.

Based on the sensor orientation Rₛ and the sensor angular velocity ˜ωₛ, which are passed from the sensor position/orientation estimation processing 400, the distance {_r^{s}ᵢ(tᵢ)}_{i=dynamic}, the Doppler velocity {wᵢ(tᵢ)}_{i=dynamic}, and stationary object detection time {tᵢ}_{i=dynamic}, which are passed from the stationary object/moving object discrimination processing 401, the sensor velocity _vₛ passed from the sensor velocity estimation processing 402, the sensor position _p_{s,j} passed from the SLAM processing 410, the moving object position {_pₘ}ⱼ, the moving object orientation {Rₘ} and {_vₘ}ⱼ, and based on moving object angular velocity {˜ωₘ}ⱼ, which are passed from the moving object detection processing 405, the point cloud correction processing 404 calculates a corrected moving object point cloud {r^{s}ᵢ(t_{N})}_{i=dynamic} and the corrected Doppler velocity {w′ᵢ(t_{N})}_{i=dynamic}. The point cloud correction processing 404 passes the calculated corrected moving object point cloud {r^{s}ᵢ(t_{N})}_{i=dynamic} and the corrected Doppler velocity {w′ᵢ(t_{N})}_{i=dynamic} to the moving object detection processing 405.

Based on the corrected moving object point cloud {_r^{s}ᵢ(t_{N})}_{i=dynamic} and the corrected Doppler velocity {w′ᵢ(t_{N})}_{i=dynamic} passed from the point cloud correction processing 404, the moving object detection processing 405 calculates a moving object position {_pₘ}ⱼ, moving object orientation {Rₘ}ⱼ and {_vₘ}ⱼ, a moving object angular velocity {˜ωₘ}ⱼ, and a moving object range {Eₘ}ⱼ, and then outputs the calculated data. Furthermore, the moving object detection processing 405 outputs the detection time tⱼ for each frame. Each value output from the moving object detection processing 405 is passed to the transmission unit 201, for example (refer to FIG. 2). Furthermore, the moving object detection processing 405 passes the calculated moving object position {_pₘ}j, the moving object orientation {Rₘ}ⱼ and {_vₘ}ⱼ, and the moving object angular velocity {˜ωₘ}ⱼ to the point cloud correction processing 404.

The SLAM processing 410 creates and outputs a map ≤_m> (“<” and “>” indicate outer brackets) based on the sensor position _pₛ, the sensor orientation Rₛ, and the sensor angular velocity ˜ωₛ which are passed from the sensor position/orientation estimation processing 400, the sensor velocity _vₛ passed from the sensor velocity estimation processing 402, and the corrected stationary object point cloud {_r^{s}ᵢ(t_{N})}_{i=static} passed from the point cloud correction processing 403. Furthermore, the SLAM processing 410 outputs the sensor position _p_{s,j}, the sensor orientation R_{s,j}, the sensor angular velocity ˜ω_{s,j}, and the sensor velocity _v_{s,j}. Furthermore, the SLAM processing 410 outputs the detection time tⱼ for each frame. Each value output from the SLAM processing 410 is passed to the transmission unit 201, for example (refer to FIG. 2).

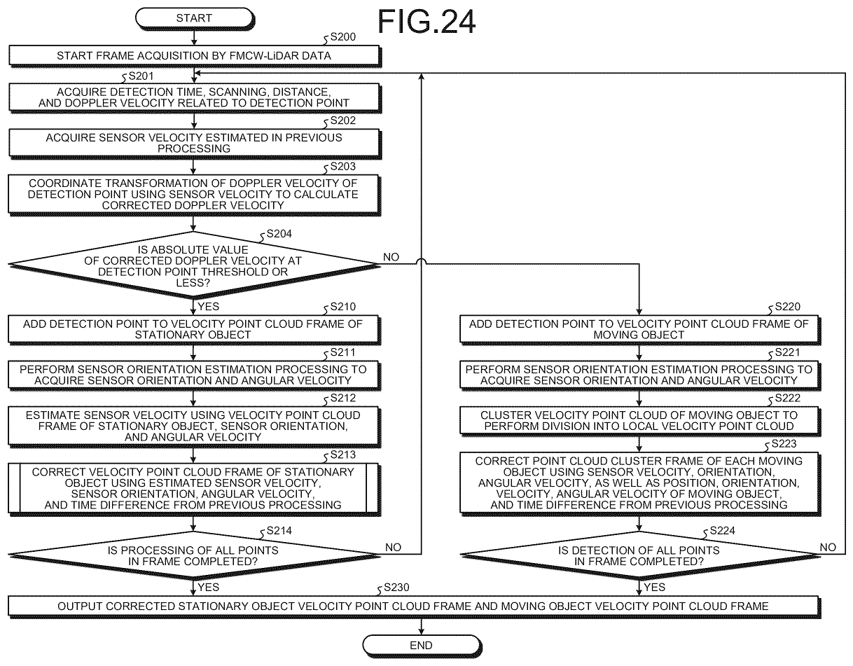

FIG. 24 is a flowchart of an example illustrating processing related to point cloud correction in the signal processing unit 20 according to the embodiment. The processing in FIG. 24 is executed for each measurement processing of one frame by the light detection and ranging sensor 110.

In step S200, the signal processing unit 20 starts acquisition of a frame based on the FMCW-LiDAR data output from the light detection and ranging sensor 110.

In the next step S201, the signal processing unit 20 uses the stationary object/moving object discrimination processing 401 to acquire the distance and the Doppler velocity, as well as the detection time, and the scanning angle, regarding the detection point at which the reception light signal has been detected. In the next step S202, the signal processing unit 20 uses the stationary object/moving object discrimination processing 401 to acquire the sensor velocity estimated in the previous processing performed by the sensor velocity estimation processing 402. In the next step S203, the signal processing unit 20 uses stationary object/moving object discrimination processing 401 to perform coordinate transformation on the Doppler velocity at the detection point by using the sensor velocity acquired in step S202, and calculates the corrected Doppler velocity.

In the next step S204, the signal processing unit 20 uses the stationary object/moving object discrimination processing 401 to determine whether the absolute value of the corrected Doppler velocity at the detection point calculated in step S203 is a threshold or less.

When the stationary object/moving object discrimination processing 401 has determined that the absolute value of the corrected Doppler velocity at the detection point is the threshold or less (step S204, “Yes”), the signal processing unit 20 proceeds to the processing of step S210, being a step related to the processing of the stationary object point cloud.

In step S210, the signal processing unit 20 uses the point cloud correction processing 403 that corrects the stationary object point cloud to add the detection point to the velocity point cloud frame of the stationary object. In the next step S211, the signal processing unit 20 uses the point cloud correction processing 403 to acquire the sensor orientation and the angular velocity estimated by the sensor position/orientation estimation processing 400. In the next step S212, the signal processing unit 20 uses the sensor velocity estimation processing 402 to estimate the sensor velocity by using the velocity point cloud frame of the stationary band, the sensor orientation, and the angular velocity.

In the next step S213, the signal processing unit 20 uses the point cloud correction processing 403 to correct the velocity point cloud frame of the stationary object by using the sensor velocity estimated in step S212, the sensor orientation and the angular velocity acquired in step S211, and a time difference from the previous processing.

In the next step S214, the signal processing unit 20 determines whether the processing for all the points in the frame has been completed by the point cloud correction processing 403. When having determined that the processing is completed by the point cloud correction processing 403 (step S214, “Yes”), the signal processing unit 20 proceeds to the processing of step S230. In contrast, when having determined that the processing is not completed by the point cloud correction processing 403 (step S214, “No”), the signal processing unit 20 returns the processing to step S201 and executes the processing for the next detection point in the frame based on the FMCW-LiDAR data.

When the stationary object/moving object discrimination processing 401 has determined, in step S204 described above, that the absolute value of the corrected Doppler velocity at the detection point exceeds the threshold (step S204, “No”), the signal processing unit 20 proceeds to the processing of step S220, being a step related to the processing of the moving object point cloud.

In step S220, the signal processing unit 20 uses the point cloud correction processing 404 that corrects the moving object point cloud to add the detection point to the velocity point cloud frame of the moving object. In the next step S221, the signal processing unit 20 uses the point cloud correction processing 404 to acquire the sensor orientation and the angular velocity estimated by the sensor position/orientation estimation processing 400.

In the next step S212, the signal processing unit 20 uses the point cloud correction processing 404 to perform clustering on the velocity point cloud of the moving object, and divides the velocity point cloud of the moving object into local velocity point clouds. That is, the signal processing unit 20 uses the point cloud correction processing 404 to divide the velocity point cloud included in the velocity point cloud frame of the moving object into the velocity point cloud of each moving object.

In the next step S223, the signal processing unit 20 uses the point cloud correction processing 404 to correct the point cloud cluster frame (local velocity point cloud) of each moving object in the velocity point cloud frame by using the sensor velocity, the sensor orientation, and the angular velocity, the position, the orientation, the velocity, and the angular velocity of the moving object, and the time difference from the previous processing.

In the next step S224, the signal processing unit 20 determines whether the processing for all the points in the frame has been completed by the point cloud correction processing 404. When having determined that the processing is completed by the point cloud correction processing 404 (step S224, “Yes”), the signal processing unit 20 proceeds to the processing of step S230. In contrast, when having determined that the processing is not completed by the point cloud correction processing 404 (step S224, “No”), the signal processing unit 20 returns the processing to step S201 and executes the processing for the next detection point in the frame.

In step S230, the signal processing unit 20 outputs the stationary object velocity point cloud frame formed with the stationary object point cloud corrected by the point cloud correction processing 403 and the moving object velocity point cloud frame formed with the moving object point cloud corrected by the point cloud correction processing 404. The output stationary object velocity point cloud frame is passed to the SLAM processing 410, for example. Furthermore, the output moving object velocity point cloud frame is passed to the moving object detection processing 405, for example.

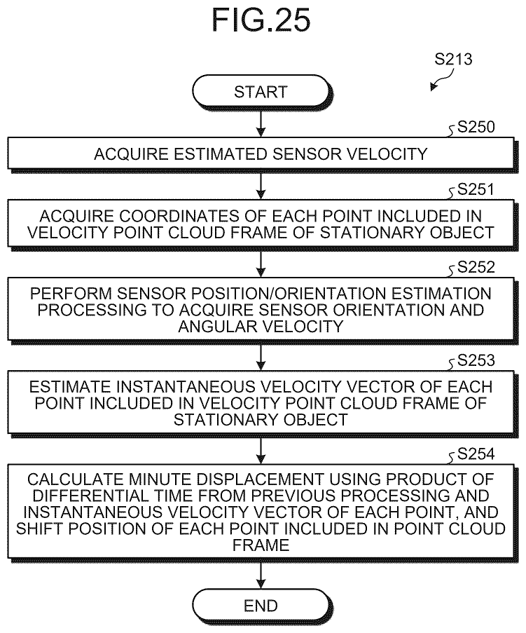

FIG. 25 is a flowchart illustrating an example of correction processing of a velocity point cloud frame of a stationary object in the signal processing unit 20 according to the embodiment. The flowchart of FIG. 25 illustrates the processing of step S213 in the above-described flowchart of FIG. 24 in more detail.

In step S250, the signal processing unit 20 uses the point cloud correction processing 403 to acquire the sensor velocity estimated by the sensor velocity estimation processing 402. In the next step S251, the signal processing unit 20 uses the point cloud correction processing 403 to acquire coordinates of each point included in the velocity point cloud frame of the stationary object. In the next step S252, the signal processing unit 20 uses the point cloud correction processing 403 to acquire the sensor orientation and the acceleration estimated by the sensor position/orientation estimation processing 400. In the next step S253, the signal processing unit 20 uses the point cloud correction processing 403 to estimate the instantaneous velocity vector of each point included in the velocity point cloud frame of the stationary object based on each value acquired in steps S250 to S252.

In the next step S254, the signal processing unit 20 uses the point cloud correction processing 403 to calculate the minute displacement of each point from the product of the differential time from the previous processing and the instantaneous velocity vector of each point. The signal processing unit 20 uses the point cloud correction processing 403 to shift the position of each point based on the calculated minute displacement of each point and correct the velocity point cloud frame of the stationary object.

### (Description Using Theoretical Formula of Processing According to Embodiment)

Here, the processing in the signal processing unit 20 according to the embodiment described with reference to FIG. 23 will be described using theoretical formulas.

### (Processing Related to Stationary Object)

First, processing related to a stationary object will be described. FIG. 26 is a schematic diagram for defining a coordinate system and each variable used in the following description. In FIG. 26, when the position of the light detection and ranging sensor 110 (hereinafter, the sensor) as a position O^{s} and the position O^{s} is set as an origin, a sensor coordinate system is defined by coordinate axes x^{s}, y^{s} and z^{s} orthogonal to each other. The angular velocity and velocity of the sensor are defined as angular velocity ->ωₛ and velocity ->vₛ, respectively.

In a stationary object (rigid body), when a position O^{m} on the rigid body is set as an origin, a rigid body coordinate system is defined by axes x^{m}, y^{m} and z^{m} orthogonal to each other. The angular velocity and velocity of the rigid body are defined as ->ωₘ and ->vₘ, respectively.

A point i which is a detection position on the rigid body is assumed to be a position indicated by a vector ->uᵢ from the position O^{m}, and the point i is supposed to have a velocity ->vᵢ and a Doppler velocity ->wᵢ with respect to the light detection and ranging sensor 110. The point i is assumed to be at a position of a distance ->rᵢ as viewed from the sensor.

In addition, when an arbitrary position O in the space is set as an origin, a world coordinate system is defined by axes x, y, and z orthogonal to each other. When viewed from the position O, which is the origin of the world coordinate system, the position O^{m}, which is the origin of the rigid body coordinate system, is assumed to be located at the position ->pₘ, and the point i is assumed to be located at the position ->pᵢ. In addition, the position O^{s}, which is the origin of the sensor coordinate system, is assumed to be located at the position ->pₛ when viewed from the position O.

(A Case where the Detection Target is a Stationary Object and the Sensor is in Motion)

First, a relationship between values in each coordinate system in a case where the detection target is a stationary object and the sensor is in motion will be described. The position vector _pᵢ of the point i is expressed by the following Formula (1).

$${p}_{i} = {p}_{s} + {r}_{i} \qquad ( 1 )$$

The velocity vector ·_pᵢ of the point i is expressed by the following Formula (2).

$${\dot{p}}_{i} = {\dot{p}}_{s} + {\tilde{ω}}_{s} {r}_{i} + {\dot{r}}_{i} \qquad ( 2 )$$

In the Formula (2), the angular velocity tilde matrix ˜ψₛ indicating the angular velocity of the rigid body is expressed as the following Formula (4) based on the angular velocity vector _ω of the following Formula (3).

$$ω = [ \begin{matrix}{ω}_{x} \\ {ω}_{y} \\ {ω}_{z}\end{matrix} ] \qquad ( 3 )$$

$$\tilde{ω} = [ \begin{matrix}0 & - {ω}_{z} & {ω}_{y} \\ {ω}_{z} & 0 & - {ω}_{x} \\ - {ω}_{y} & {ω}_{x} & 0\end{matrix} ] \qquad ( 4 )$$

In Formula (2), when the rigid body coordinate system is stationary, the following Formula (5) holds.

$${\dot{p}}_{i} = 0 \qquad ( 5 )$$

In addition, according to the vector constant expression, the relationship of the following Formula (6) holds for the distance _rᵢ and the angular velocity tilde matrix ˜wₛ.

$${r}_{i} \cdot {\tilde{ω}}_{s} {r}_{i} = 0 \qquad ( 6 )$$

Furthermore, the Doppler velocity wᵢ of the point i is expressed by the following Formula (7).

$${w}_{i} = \frac{{r}_{i}}{{r}_{i}} \cdot {\dot{r}}_{i} \qquad ( 7 )$$

The following Formula (8) is obtained by the above-described Formulas (2) and (5) to (7).

$${\dot{p}}_{i} = \frac{{r}_{i}}{{r}_{i}} \cdot {\dot{p}}_{s} + \frac{{r}_{i}}{{r}_{i}} \cdot {\tilde{ω}}_{s} {r}_{i} + {w}_{i} \qquad ( 8 )$$

Formula (8) is transformed into Formula (9) below to rearrange the relationship between the values, so as to obtain the relationship between the Doppler velocity wᵢ and the velocity vector ·_pᵢ at the point i.

$${w}_{i} = - \frac{{r}_{i}}{{r}_{i}} \cdot {\dot{p}}_{s} \qquad ( 9 )$$

### (Estimation of Sensor Velocity Using Doppler Velocity)

Next, the following will describe a method of estimating the sensor velocity using the Doppler velocity by the sensor velocity estimation processing 402 in a case where the sensor is in motion and the point i is a stationary object. The relationship between the Doppler velocity wᵢ and the sensor velocity vₛ is expressed by the following Formula (10) based on Formula (9) described above.

$${w}_{i} = - \frac{{r}_{i}}{{r}_{i}} \cdot {\dot{p}}_{s} \qquad ( 10 )$$

Formula (10) can be expressed as the following Formula (11) using the sensor orientation Rₛ.

$${w}_{i} = - \frac{{R}_{s} {r}_{i}^{s}}{{r}_{i}} \cdot {v}_{s} \qquad ( 11 )$$

In Formula (11), −(r^{s}ᵢ/rᵢ) indicates a beam direction vector, which can be expressed as the following Formula (12) using a matrix.

$$\frac{{r}_{i}^{s}}{{r}_{i}} = [ \begin{matrix}cos {θ}_{hi} cos {θ}_{vi} \\ sin {θ}_{hi} cos {θ}_{vi} \\ sin {θ}_{vi}\end{matrix} ] \qquad ( 12 )$$

By substituting Formula (12) into Formula (11), the following Formula (13) is obtained.

$${w}_{i} = - {R}_{s} [ \begin{matrix}cos {θ}_{hi} cos {θ}_{vi} \\ sin {θ}_{hi} cos {θ}_{vi} \\ sin {θ}_{vi}\end{matrix} ] \cdot [ \begin{matrix}{v}_{sx} \\ {v}_{sy} \\ {v}_{sz}\end{matrix} ] \qquad ( 13 )$$

Here, based on Formula (13), the value _eᵢ is defined as the following Formula (14).

$${e}_{i} = - {R}_{s} [ \begin{matrix}cos {θ}_{hi} cos {θ}_{vi} \\ sin {θ}_{hi} cos {θ}_{vi} \\ sin {θ}_{vi}\end{matrix} ] \qquad ( 14 )$$

Using Formula (14), the following Formula (15) representing the sensor velocity _vₛ can be obtained. In the sensor velocity estimation processing 402, sensor velocity _vₛ is estimated by this Formula (15).

$${v}_{s} = [ \begin{matrix}{v}_{sx} \\ {v}_{sy} \\ {v}_{sz}\end{matrix} ] = {[ \begin{matrix}{e}_{x 1} & {e}_{y 1} & {e}_{z 1} \\ ⋮ & ⋮ & ⋮ \\ {e}_{xN} & {e}_{yN} & {e}_{zN}\end{matrix} ]}^{†} [ \begin{matrix}{w}_{1} \\ ⋮ \\ {w}_{N}\end{matrix} ] \qquad ( 15 )$$

Note that, in Formula (15), a matrix based on the value eᵢ indicates a matrix of beam direction vectors in the stationary object and the world coordinate system.

### (Stationary Object Point Cloud Correction Processing)

Next, stationary object point cloud correction processing performed by the point cloud correction processing 403 in a case where the sensor is in motion will be described.

The velocity vector _vᵢ of the point i is expressed by the following Formula (16).

$${v}_{i} = {v}_{s} + {\tilde{ω}}_{s} {r}_{i} + {\dot{r}}_{i} \qquad ( 16 )$$

Formula (16) is transformed to obtain Formula (17).

$${R}_{s} {\dot{r}}_{i}^{s} + {\tilde{ω}}_{s} {R}_{s} {r}_{i}^{s} + {v}_{s} = 0 \qquad ( 17 )$$

Formula (17) is further transformed to obtain the following Formula (18).

$$\frac{{dr}_{i}^{s}}{dt} = - {R}_{s}^{- 1} ( {\tilde{ω}}_{s} {R}_{s} {r}_{i}^{s} - {v}_{s} ) \qquad ( 18 )$$

Formula (18) is transformed into a discrete equation to obtain the following Formula (19). In the Formula (19), Δtᵢ is the measurement differential time and is obtained by Δtᵢ=tᵢ−tᵢ₋₁.

$$Δ {r}_{i}^{s} = - {R}_{s}^{- 1} ( {\tilde{ω}}_{s} {R}_{s} {r}_{i}^{s} - {v}_{s} ) Δ {t}_{i} \qquad ( 19 )$$

Based on Formula (19), the correction coefficient X^{s}ᵢ is defined as the following Formula (20).

$${X}_{i}^{s} = - {R}_{s}^{- 1} ( {\tilde{ω}}_{s} {R}_{s} {r}_{i}^{s} - {v}_{s} ) \qquad ( 20 )$$

Using the measurement differential time Δtᵢ and the correction coefficient X^{s}ᵢ in Formula (20), the position of each point of the stationary object point cloud is corrected by the following Formula (21).

$$\begin{matrix}{r}_{0}^{s} ( {t}_{N} ) = & {x}_{0}^{s} ( {t}_{N} ) Δ {t}_{N} & + {x}_{0}^{s} ( {t}_{N - 1} ) Δ {t}_{N - 1} & … & + {x}_{0}^{s} ( {t}_{1} ) Δ {t}_{1} & + {r}_{0}^{s} ( {t}_{0} ) \\ ⋮ & & & & & ⋮ \\ {r}_{N - 2}^{s} ( {t}_{N} ) = & {x}_{N - 2}^{s} ( {t}_{N} ) Δ {t}_{N} & + {x}_{N - 2}^{s} ( {t}_{N - 1} ) Δ {t}_{N - 1} & & … & + {r}_{N - 2}^{s} ( {t}_{N - 2} ) \\ {r}_{N - 1}^{s} ( {t}_{N} ) = & {x}_{N - 1}^{s} ( {t}_{N} ) Δ {t}_{N} & & & & + {r}_{N - 1}^{s} ( {t}_{N - 1} ) \\ {r}_{N}^{s} ( {t}_{N} ) = & & & & & + {r}_{N}^{s} ( {t}_{N} )\end{matrix} \qquad ( 21 )$$

In the Formula (21), the left side indicates the position vector of each corrected detection point (point i) in the sensor coordinate system. The last term on the right side indicates a position vector in the sensor coordinate system of each detection point before correction. In the point cloud correction processing 403, the position of each point of the stationary object point cloud is corrected by the Formula (21) by adding the position correction value to the position vector of the detection point (point i) in the sensor coordinate system before the correction of each detection point using the correction term based on the measurement differential time Δtᵢ and the correction coefficient X^{s}ᵢ at the point i.

### (Processing Related to Moving Object)

Next, processing related to a moving object will be described. The coordinate system is the same as that in FIG. 26 except that the stationary object (rigid body) in FIG. 26 described above is replaced with a moving object (rigid body), and thus the description thereof is omitted.

(Case where the Detection Target is a Moving Object and the Sensor is in Motion)

First, a relationship between values in each coordinate system in a case where the detection target is a moving object and the sensor is in motion will be described. The position vector _pᵢ of the point i (detection position) is expressed by the following Formula (22).

$${p}_{i} = {p}_{m} + {u}_{i} \qquad ( 22 )$$

The velocity vector ·_pᵢ in the rigid body coordinate system of the point i is expressed by the following Formula (23). Note that the velocity vector ·_pᵢ in the sensor coordinate system of the point i is similar to the above-described Formula (2), and thus the description thereof will be omitted here.

$$\dot{{p}_{i}} = \dot{{p}_{m}} + {\tilde{ω}}_{m} {u}_{i} \qquad ( 23 )$$

Using the above-described Formula (6) by the vector constant equation and the velocity vector ·_pᵢ of the sensor coordinate system of the point i in Formula (2), Formula (23) is transformed to obtain the following Formula (24).

$$\frac{{r}_{i}}{{r}_{i}} \cdot \dot{{p}_{m}} + \frac{{r}_{i}}{{r}_{i}} \cdot {\tilde{ω}}_{m} {u}_{i} = \frac{{r}_{i}}{{r}_{i}} \cdot \dot{{r}_{s}} + \frac{{r}_{i}}{{r}_{i}} \cdot {\tilde{ω}}_{s} {r}_{i} + {w}_{i} \qquad ( 24 )$$

Formula (24) is further transformed into the following Formula (25) to rearrange the relationship between the individual values.

$${w}_{i} + \frac{{r}_{i}}{{r}_{i}} \cdot \dot{{p}_{s}} = \frac{{r}_{i}}{{r}_{i}} \cdot ( \dot{{p}_{m}} + {\tilde{ω}}_{m} {u}_{i} ) \qquad ( 25 )$$

### (Velocity Discrimination Between Stationary Object and Moving Object)

Next, velocity discrimination between a stationary object and a moving object by the stationary object/moving object discrimination processing 401 will be described. By correcting the Doppler velocity wᵢ in accordance with the motion of the point i, a corrected Doppler velocity wᵢ′ is obtained by the following Formula (26).

$${w}_{i}^{′} = {w}_{i} + \frac{{r}_{i}}{{r}_{i}} \cdot {v}_{s} \qquad ( 26 )$$

The stationary object/moving object discrimination processing 401 performs threshold determination on the corrected Doppler velocity wᵢ′, thereby determining whether the point i is a moving object or a stationary object. For example, a moving object determination threshold vₜₕ₁ for determining a moving object and a stationary object determination threshold vₜₕ₂ for determining a stationary object are set. When the absolute value of the corrected Doppler velocity wᵢ′ is less than the stationary object determination threshold vₜₕ₂ (|wᵢ′|<vₜₙ₂), it is determined that the point i is a stationary object. In a case where the absolute value of the corrected Doppler velocity wᵢ′ exceeds the moving object determination threshold vₜₕ₁ (|wᵢ′|>vₜₕ₁), it is determined that the point i is a moving object.

### (Estimation of Sensor Velocity Using Doppler Velocity)

Next, the following will describe a method of estimating the sensor velocity using the Doppler velocity by the sensor velocity estimation processing 402 in a case where the sensor is in motion and the point i is a moving object. The relative velocity of the sensor with respect to the moving object is expressed by the following Formula (27) using the Doppler velocity wᵢ.

$${w}_{i} - \frac{{r}_{i}}{{r}_{i}} \cdot ( {\tilde{ω}}_{m} {u}_{i} ) = - \frac{{r}_{i}}{{r}_{i}} \cdot ( {v}_{s} - {v}_{m} ) \qquad ( 27 )$$

Formula (27) is transformed using the sensor orientation Rₛ to obtain the following Formula (28).

$${w}_{i} - \frac{{R}_{s} {r}_{i}^{s}}{{r}_{i}} \cdot ( {\tilde{ω}}_{m} {u}_{i} ) = - \frac{{R}_{s} {r}_{i}^{s}}{{r}_{i}} \cdot ( {v}_{s} - {v}_{m} ) \qquad ( 28 )$$

Here, the value _ηᵢ is defined as in the following Formula (29).

$${η}_{i} = {\tilde{ω}}_{m} {u}_{i} \qquad ( 29 )$$

Vector _uᵢ in Formula (29) is obtained by the following Formula (30).

$${u}_{i} = {p}_{s} + {r}_{i} - {p}_{m} \qquad ( 30 )$$

Formula (29) is expressed as the following Formula (31) using a determinant.

$$[ \begin{matrix}{η}_{ix} \\ {η}_{iy} \\ {η}_{iz}\end{matrix} ] = [ \begin{matrix}0 & - {ω}_{mz} & {ω}_{my} \\ {ω}_{mz} & 0 & - {ω}_{mx} \\ - {ω}_{my} & {ω}_{mx} & 0\end{matrix} ] [ \begin{matrix}{x}_{s} + {x}_{i} - {x}_{m} \\ {y}_{s} + {y}_{i} - {y}_{m} \\ {z}_{s} + {z}_{i} - {z}_{m}\end{matrix} ] \qquad ( 31 )$$

The above-described Formula (28) is transformed using Formulas (29) to (31) to obtain the following Formula (32).

$${w}_{i} - {R}_{s} [ \begin{matrix}cos {θ}_{hi} cos {θ}_{vi} \\ sin {θ}_{hi} cos {θ}_{vi} \\ sin {θ}_{vi}\end{matrix} ] \cdot [ \begin{matrix}{η}_{ix} \\ {η}_{iy} \\ {η}_{iz}\end{matrix} ] = - {R}_{s} [ \begin{matrix}cos {θ}_{hi} cos {θ}_{vi} \\ sin {θ}_{hi} cos {θ}_{vi} \\ sin {θ}_{vi}\end{matrix} ] \cdot [ \begin{matrix}{v}_{sx} - {v}_{mx} \\ {v}_{sy} - {v}_{mx} \\ {v}_{sz} - {v}_{mx}\end{matrix} ] \qquad ( 32 )$$

Here, a value ξᵢ is defined as in the following Formula (33).

$${ξ}_{i} = {w}_{i} - {R}_{s} [ \begin{matrix}cos {θ}_{hi} cos {θ}_{vi} \\ sin {θ}_{hi} cos {θ}_{vi} \\ sin {θ}_{vi}\end{matrix} ] \cdot [ \begin{matrix}{η}_{ix} \\ {η}_{iy} \\ {η}_{iz}\end{matrix} ] \qquad ( 33 )$$

The above-described Formula (32) is transformed using the value ξᵢ of the Formula (33) and the value eᵢ defined using the Formula (14) to obtain the following Formula (34) indicating a moving object velocity _vₘ.

$${v}_{m} = [ \begin{matrix}{v}_{mx} \\ {v}_{my} \\ {v}_{mz}\end{matrix} ] = {v}_{s} - {[ \begin{matrix}{e}_{x 1} & {e}_{y 1} & {e}_{z 1} \\ ⋮ & ⋮ & ⋮ \\ {e}_{xN} & {e}_{yN} & {e}_{zN}\end{matrix} ]}^{†} [ \begin{matrix}{ξ}_{1} \\ ⋮ \\ {ξ}_{N}\end{matrix} ] \qquad ( 34 )$$

### (Moving Object Point Cloud Correction Processing)

Next, the following will describe moving object point cloud correction processing performed by the point cloud correction processing 404 in a case where the sensor is in motion.

The velocity vector _vᵢ of the point i in the sensor coordinate system is expressed by the following Formula (35).

$${v}_{i} = {v}_{s} + {\tilde{ω}}_{s} {r}_{i} + {\dot{r}}_{i} \qquad ( 35 )$$

The velocity vector _vᵢ of point i in the rigid body coordinate system is expressed by the following Formula (36).

$${v}_{i} = {v}_{m} + {\tilde{ω}}_{m} {u}_{i} \qquad ( 36 )$$

Formula (35) and Formula (36) are assumed to be equal, and Formula (35) is transformed using the sensor orientation Rₛ to obtain the following Formula (37).

$${R}_{s} {\dot{r}}_{i}^{s} + {\tilde{ω}}_{s} {R}_{s} {r}_{i}^{s} + {v}_{s} = {v}_{m} + {\tilde{ω}}_{m} {u}_{i} \qquad ( 37 )$$

The above-described Formula (30) is substituted into the vector _uᵢ of the Formula (37) to obtain the following Formula (38).

$$\frac{{dr}_{i}^{s}}{dt} = - {R}_{s}^{- 1} ( {\tilde{ω}}_{s} {R}_{s} {r}_{i}^{s} - {v}_{s} + {v}_{m} + {\tilde{ω}}_{m} ( {p}_{s} + {r}_{i} - {p}_{m} ) ) \qquad ( 38 )$$

Formula (38) is transformed into a discrete equation, and the measurement differential time Δtᵢ is applied to obtain the following Formula (39).

$$Δ {r}_{i}^{s} = - {R}_{s}^{- 1} ( {\tilde{ω}}_{s} {R}_{s} {r}_{i}^{s} - {v}_{s} + {v}_{m} + {\tilde{ω}}_{m} ( {p}_{s} + {r}_{i} - {p}_{m} ) ) Δ {t}_{i} \qquad ( 39 )$$

Based on Expression 39, the correction coefficient σ^{s}ᵢ is defined as in the following Formula (40).

$${σ}_{i}^{s} = - {R}_{s}^{- 1} ( {\tilde{ω}}_{s} {R}_{s} {r}_{i}^{s} - {v}_{s} + {v}_{m} + {\tilde{ω}}_{m} ( {p}_{s} + {r}_{i} - {p}_{m} ) ) \qquad ( 40 )$$

Using the measurement differential time Δtᵢ and the correction coefficient σ^{s}ᵢ indicated in Formula (40), the position of each point of the moving object point cloud is corrected by the following Formula (41).

$$\begin{matrix}{r}_{0}^{s} ( {t}_{N} ) = & {σ}_{0}^{s} ( {t}_{N} ) Δ {t}_{N} & + {σ}_{0}^{s} ( {t}_{N - 1} ) Δ {t}_{N - 1} & … & + {σ}_{0}^{s} ( {t}_{1} ) Δ {t}_{1} & + {r}_{0}^{s} ( {t}_{0} ) \\ ⋮ & & & & & ⋮ \\ {r}_{N - 2}^{s} ( {t}_{N} ) = & {σ}_{0}^{s} ( {t}_{N - 2} ) Δ {t}_{N} & + {σ}_{N - 2}^{s} ( {t}_{N - 1} ) Δ {t}_{N - 1} & & … & + {r}_{N - 2}^{s} ( {t}_{N - 2} ) \\ {r}_{N - 1}^{s} ( {t}_{N} ) = & {σ}_{0}^{s} ( {t}_{N - 1} ) Δ {t}_{N} & ⋯ & & & + {r}_{N - 1}^{s} ( {t}_{N - 1} ) \\ {r}_{N}^{s} ( {t}_{N} ) = & & & & & + {r}_{N}^{s} ( {t}_{N} )\end{matrix} \qquad ( 41 )$$

In the Formula (41), the left side indicates the position vector of each corrected detection point (point i) in the sensor coordinate system. The last term on the right side indicates a position vector in the sensor coordinate system of each detection point before correction. In the point cloud correction processing 404, the position of each point of the moving object point cloud is corrected by the Formula (41) by adding the position correction value to the position vector of the detection point (point i) in the sensor coordinate system before the correction of each detection point using the correction term based on the measurement differential time Δtᵢ and the correction coefficient σ^{s}ᵢ at the point i.

### (3. First Modification of Embodiment of Present Disclosure)

Next, a first modification of the embodiment of the present disclosure will be described. The first modification of the embodiment is an example in which a configuration of controlling scanning of the light detection and ranging sensor 110 has been added to the signal processing system 1 according to the embodiment illustrated in FIG. 2.

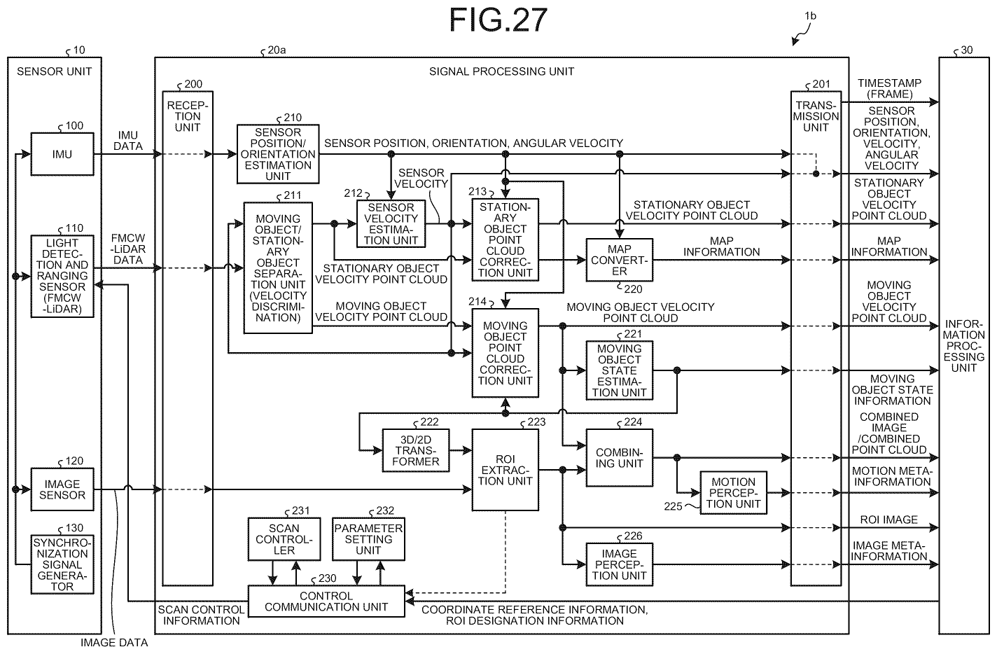

FIG. 27 is a block diagram illustrating a configuration of an example of the signal processing system according to the first modification of the embodiment. In a signal processing system 1a in FIG. 27, a signal processing unit 20a has additional units, specifically, a control communication unit 230, a scan controller 231, and a parameter setting unit 232, added to the signal processing unit 20 in the signal processing system 1 in FIG. 2.

Based on coordinate reference information and ROI designation information transmitted from the information processing unit 30, the control communication unit 230 generates scan control information for controlling scanning in the light detection and ranging sensor 110.

For example, the control communication unit 230 passes the received coordinate reference information to the parameter setting unit 232. Based on the received coordinate reference information, the parameter setting unit 232 sets an initial value related to scanning of the light detection and ranging sensor 110, for example. The control communication unit 230 passes the initial value set by the parameter setting unit 232 to the light detection and ranging sensor 110 as scan control information. The light detection and ranging sensor 110 initializes a scanning mechanism and the like in accordance with the scan control information passed from the control communication unit 230.

Furthermore, for example, the control communication unit 230 passes received ROI designation information to the scan controller 231. The ROI designation information may include, for example, coordinate information set as a region of interest for the image data. For example, based on the received ROI designation information, the scan controller 231 converts the coordinate information into information of horizontal and vertical angular ranges for controlling the scanning range in the light detection and ranging sensor 110, and passes the information to the control communication unit 230. The control communication unit 230 passes the information of the horizontal and vertical angular ranges passed from the scan controller 231 to the light detection and ranging sensor 110 as scan control information. The light detection and ranging sensor 110 controls the scanning range in accordance with the received scan control information.

This makes it possible to perform control the light detection and ranging sensor 110 to exclusively scan the designated region of interest, leading to reduction of the time required for scanning. In addition, it is also possible to control the light detection and ranging sensor 110 to perform exclusive and high-density scanning of the designated region of interest, leading to achievement of more accurate operation perception and image perception in the region of interest.

Not limited to this, the ROI designation information may be passed from the ROI extraction unit 223. That is, based on the point cloud by the 2D coordinates passed from the 3D/2D transformer 222, the ROI extraction unit 223 passes information indicating the region of interest extracted from the image data passed from the image sensor 120 via the reception unit 200 to the control communication unit 230 as ROI designation information. The control communication unit 230 passes the ROI designation information passed from the ROI extraction unit 223 to the scan controller 231.

### (4. Second Modification of Embodiment of Present Disclosure)

Next, a second modification of the embodiment of the present disclosure will be described. The second modification of the embodiment is an example in which the image sensor 120 and the configuration for performing processing related to image data have been omitted from the signal processing system 1 according to the embodiment illustrated in FIG. 2.

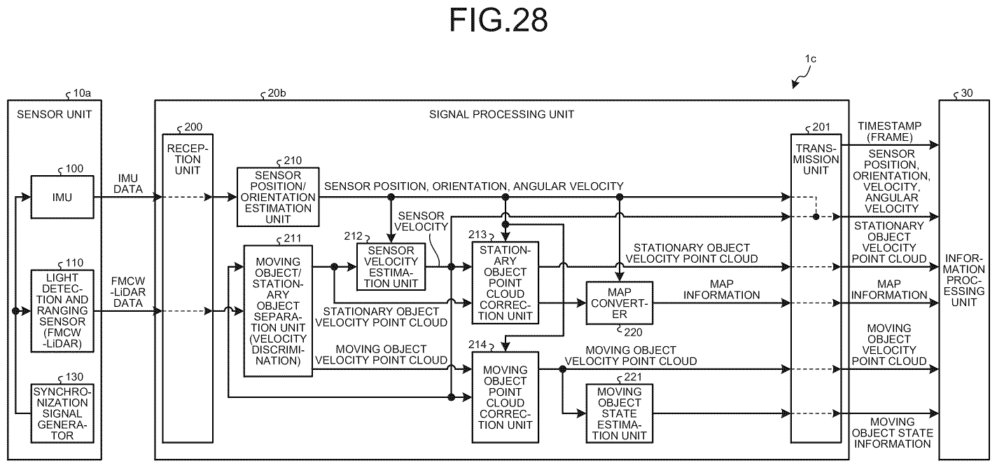

FIG. 28 is a block diagram illustrating a configuration of an example of the signal processing system according to the second modification of the embodiment. In FIG. 28, a signal processing system 1c has a sensor unit 10a, in which the image sensor 120 is omitted as compared with the sensor unit 10 illustrated in FIG. 2. Furthermore, the signal processing system 1b has a signal processing unit 20b, in which the components related to the processing of the image data are omitted as compared with the signal processing unit 20 illustrated in FIG. 2, specifically, the 3D/2D transformer 222, the ROI extraction unit 223, the combining unit 224, the motion perception unit 225, and the image perception unit 226 are omitted.

Even in the configuration of the signal processing system 1c according to the second modification of the present embodiment, it is possible to output map information and output a stationary object velocity point cloud and a moving object velocity point cloud. When there is no need to have the motion meta-information obtained by motion perception of the moving object or the image meta-information obtained by image perception cost reduction can be achieved by applying the configuration of the signal processing system 1c according to the second modification of the embodiment.

### (5. Other Embodiments According to Present Disclosure)

In the above-described embodiment and each modification thereof, the stationary object point cloud correction unit 213 and the moving object point cloud correction unit 214 always perform the correction processing on the entire frame in the FMCW-LiDAR. However, the target of correction processing not limited to this example. For example, whether to perform correction by the stationary object point cloud correction unit 213 and the moving object point cloud correction unit 214 may be set for the entire frame, or may be set for one or more regions set in the frame.

Furthermore, for example, whether to perform correction by the stationary object point cloud correction unit 213 and the moving object point cloud correction unit 214 may be set for each point (detection point) included in the frame. In this case, the determination on whether to perform correction for each point may be made based on at least one piece of attribute information of each point in the subject frame or an attribute value of a point in a frame before the subject frame.

Determination as to whether to perform such correction by the stationary object point cloud correction unit 213 and the moving object point cloud correction unit 214, and in which unit (region, point by point, entire frame) the correction is to be performed can be designated from the outside of the signal processing unit 20. For example, the information processing unit 30 may perform this designation on the signal processing unit 20. Furthermore, in the first modification of the embodiment describe above, the information processing unit 30 may transmit designation information indicating designation to the control communication unit 230 in the signal processing unit 20a. The control communication unit 230 may control the operations of the stationary object point cloud correction unit 213 and the moving object point cloud correction unit 214 based on the designation information.

Furthermore, in the above-described embodiment and the modifications thereof, information indicating the presence or absence of correction may be added, in accordance with the unit of correction described above, to each data such as the stationary object velocity point cloud and the moving object velocity point cloud, which is output from the transmission unit 201.

The effects described in the present specification are merely examples, and thus, there may be other effects, not limited to the exemplified effects.

Note that the present technology can also have the following configurations.

(1) a Signal Processing Apparatus Comprising:
a reception unit configured to receive velocity point cloud data from a first sensor, the velocity point cloud data including a plurality of points, each point having velocity information and time-point information;
a correction unit configured to correct at least one attribute value related to at least one point included in the velocity point cloud data, based on an estimated value at a predetermined time-point; and
a transmission unit configured to add corrected time-point information indicating the predetermined time-point, to the attribute value corrected by the correction unit and transmit the corrected attribute value together with the corrected time-point information.
   (2) The signal processing apparatus according to the above (1), wherein
the time-point information indicates a time-point at which each of the plurality of points is acquired by the first sensor.

(3) The signal processing apparatus according to the above (1) or (2), wherein
the predetermined time-point is given as at least one time-point for each frame of a detection operation by the first sensor.

(4) The signal processing apparatus according to any one of the above (1) to (3), wherein
the reception unit
further receives inertial measurement data from a second sensor, and
the correction unit
calculates the estimated value based on the velocity information, the time-point information, and the inertial measurement data.

(5) The signal processing apparatus according to any one of the above (1) to (4), wherein
the correction unit
sets at least a moving object velocity point cloud that is a velocity point cloud of moving objects, as a target of the correction.

(6) The signal processing apparatus according to the above (5), wherein
the correction unit
sets the moving object velocity point cloud as a target of first correction by the correction unit, and set a stationary object velocity point cloud that is a velocity point cloud of a stationary object as a target of second correction by the correction unit.

(7) The signal processing apparatus according to the above (6), further comprising
a map generator configured to generate map information based on the stationary object velocity point cloud corrected by the correction unit and inertial measurement data received from a second sensor.

(8) The signal processing apparatus according to any one of the above (5) to (7), further comprising
a region-of-interest extraction unit configured to extract a region of interest, wherein
the reception unit
further receives image data from a third sensor, and
the region-of-interest extraction unit
extracts the region of interest from the image data based on a region including the moving object, the region including the moving object being estimated based on the moving object velocity point cloud corrected by the correction unit.

(9) The signal processing apparatus according to the above (8), further comprising
a motion perception unit configured to perceive a motion of the moving object based on combined data obtained by combining the moving object velocity point cloud and image data of the region of interest among the image data.

(10) The information processing apparatus according to the above (8) or (9), further comprising
an image perception unit configured to perform image perception processing based on image data of the region of interest among the image data.

(11) The signal processing apparatus according to any one of the above (1) to (10), wherein
the reception unit
further receives, from the first sensor, type information indicating a type of a detection operation by the first sensor.

(12) A signal processing method to be executed by a processor, the method comprising:
receiving, from a first sensor, a velocity point cloud including a plurality of points, each point having velocity information and time-point information;
correcting at least one attribute value related to at least one point included in the velocity point cloud, based on an estimated value at a predetermined time-point; and
adding corrected time-point information indicating the predetermined time-point to the attribute value corrected by the correction and transmitting the corrected attribute value together with the corrected time-point information.

(13) An information processing apparatus comprising an execution unit configured to execute a predetermined function in response to a request from an application section, wherein
the execution unit includes:
a reception unit configured to receive, from a first sensor, a velocity point cloud including a plurality of points, each point having velocity information and time-point information;
a correction unit configured to correct at least one attribute value related to at least one point included in the velocity point cloud based on an estimated value at a predetermined time-point; and
an interface unit configured to receive the request from the application section, and
the interface unit
passes the velocity point cloud corrected by the correction unit to the application section in response to the request.

(14) The information processing apparatus according to the above (13), wherein
the time-point information indicates a time-point at which each of the plurality of points is acquired by the first sensor.

(15) The information processing apparatus according to the above (13) or (14), wherein
the predetermined time-point is given as at least one time-point for each frame of a detection operation by the first sensor.

(16) The information processing apparatus according to any one of the above (13) to (15), wherein
the correction unit
calculates the estimated value based on the velocity information, the time-point information, and inertial measurement data received from a second sensor by the reception unit.

(17) The information processing apparatus according to any one of the above (13) to (16), wherein
the correction unit
sets at least a moving object velocity point cloud that is a velocity point cloud of moving objects, as a target of the correction.

(18) The information processing apparatus according to the above (17), wherein
the correction unit
sets the moving object velocity point cloud as a target of first correction by the correction unit, and set a stationary object velocity point cloud that is a velocity point cloud of a stationary object as a target of second correction by the correction unit.

(19) An information processing apparatus comprising:
an application section configured to execute predetermined processing; and
an interface unit configured to pass a request related to the predetermined processing to an execution unit configured to execute a predetermined function, wherein
the application section
receives, via the interface unit, a velocity point cloud that is passed from the execution unit in response to the request and in which at least one attribute value related to at least one point included in the velocity point cloud including a plurality of points each having velocity information and time-point information received by the execution unit from a first sensor is corrected based on an estimated value on a predetermined time-point, and executes the predetermined processing based on the received velocity point cloud.

(20) The information processing apparatus according to the above (19), wherein
the application section includes
a map generator configured to generate map information based on a stationary object velocity point cloud that is a velocity point cloud of a stationary object and corrected based on the estimated value, and inertial measurement data received by the execution unit from a second sensor, the stationary object velocity point cloud and the inertial measurement data being individually received via the interface unit.

(21) The information processing apparatus according to the above (19) or (20), wherein
the application section includes
a region-of-interest extraction unit configured to extract a region of interest on image data received by the execution unit from a third sensor via the interface unit, the extraction being performed based on a region including a moving object, the region including the moving object being estimated based on a moving object velocity point cloud that is a velocity point cloud of a moving object, the moving object velocity point cloud being corrected based on the estimated value and received via the interface unit.

(22) The information processing apparatus according to the above (21), wherein
the application section includes
a motion perception unit configured to perceive a motion of the moving object based on combined data obtained by combining the moving object velocity point cloud and image data of the region of interest among the image data.

(23) The information processing apparatus according to the above (21) or (22),
in which the application section includes:
an image perception unit configured to perform image perception processing based on image data of the region of interest among the image data.

### REFERENCE SIGNS LIST

1, 1a, 1b, 1c SIGNAL PROCESSING SYSTEM
10, 10a SENSOR UNIT
20, 20a, 20b SIGNAL PROCESSING UNIT
30 INFORMATION PROCESSING UNIT
40 SCANNING LINE
41, 41a, 41b, 41ₛₜ EMISSION POINT
42₁, 42₂, 42_{N} SCANNING LINE
45 ANGULAR RANGE
46 SCANNING RANGE
50a, 50b, 52 OBJECT
60a, 60b, 60c FRAME
61 PIXEL
100 IMU
110 LIGHT DETECTION AND RANGING SENSOR
111 OPTICAL SCAN UNIT
112 LIGHT TRANSMISSION/RECEPTION UNIT
113 RECEPTION SIGNAL PROCESSING UNIT
114 OPTICAL SCAN CONTROLLER
115, 201 TRANSMISSION UNIT
120 IMAGE SENSOR
130 SYNCHRONIZATION SIGNAL GENERATOR
200 RECEPTION UNIT
210 SENSOR POSITION/ORIENTATION ESTIMATION UNIT
211 MOVING OBJECT/STATIONARY OBJECT SEPARATION UNIT
212 SENSOR VELOCITY ESTIMATION UNIT
213 STATIONARY OBJECT POINT CLOUD CORRECTION UNIT
214 MOVING OBJECT POINT CLOUD CORRECTION UNIT
220 MAP CONVERTER
221 MOVING OBJECT STATE ESTIMATION UNIT
222 3D/2D TRANSFORMER
223 ROI EXTRACTION UNIT
224 COMBINING UNIT
225 MOTION PERCEPTION UNIT
226 IMAGE PERCEPTION UNIT
230 CONTROL COMMUNICATION UNIT
231 SCAN CONTROLLER
232 PARAMETER SETTING UNIT
400 SENSOR POSITION/ORIENTATION ESTIMATION PROCESSING
401 STATIONARY OBJECT/MOVING OBJECT DISCRIMINATION PROCESSING
402 SENSOR VELOCITY ESTIMATION PROCESSING
403, 404 POINT CLOUD CORRECTION PROCESSING
405 MOVING OBJECT DETECTION PROCESSING
1000 SENSOR GROUP
1010 FIRMWARE
2000, 3000 PROCESSOR
2010, 3010 LIBRARY SECTION
2020, 3020 APPLICATION SECTION
2030 OS
2040 API CALLING UNIT
2041 API PROCESSING UNIT

1. A signal processing apparatus comprising:
a reception unit configured to receive velocity point cloud data from a first sensor, the velocity point cloud data including a plurality of points, each point having velocity information and time-point information;
a correction unit configured to correct at least one attribute value related to at least one point included in the velocity point cloud data, based on an estimated value at a predetermined time-point; and
a transmission unit configured to add corrected time-point information indicating the predetermined time-point, to the attribute value corrected by the correction unit and transmit the corrected attribute value together with the corrected time-point information.

2. The signal processing apparatus according to claim 1, wherein
the time-point information indicates a time-point at which each of the plurality of points is acquired by the first sensor.

3. The signal processing apparatus according to claim 1, wherein
the predetermined time-point is given as at least one time-point for each frame of a detection operation by the first sensor.

4. The signal processing apparatus according to claim 1, wherein
the reception unit
further receives inertial measurement data from a second sensor, and
the correction unit
calculates the estimated value based on the velocity information, the time-point information, and the inertial measurement data.

5. The signal processing apparatus according to claim 1, wherein
the correction unit
sets at least a moving object velocity point cloud that is a velocity point cloud of moving objects, as a target of the correction.

6. The signal processing apparatus according to claim 5, wherein
the correction unit
sets the moving object velocity point cloud as a target of first correction by the correction unit, and set a stationary object velocity point cloud that is a velocity point cloud of a stationary object as a target of second correction by the correction unit.

7. The signal processing apparatus according to claim 6, further comprising
a map generator configured to generate map information based on the stationary object velocity point cloud corrected by the correction unit and inertial measurement data received from a second sensor.

8. The signal processing apparatus according to claim 5, further comprising
a region-of-interest extraction unit configured to extract a region of interest, wherein
the reception unit
further receives image data from a third sensor, and
the region-of-interest extraction unit
extracts the region of interest from the image data based on a region including the moving object, the region including the moving object being estimated based on the moving object velocity point cloud corrected by the correction unit.

9. The signal processing apparatus according to claim 8, further comprising
a motion perception unit configured to perceive a motion of the moving object based on combined data obtained by combining the moving object velocity point cloud and image data of the region of interest among the image data.

10. The signal processing apparatus according to claim 1, wherein
the reception unit
further receives, from the first sensor, type information indicating a type of a detection operation by the first sensor.

11. A signal processing method to be executed by a processor, the method comprising:
receiving, from a first sensor, a velocity point cloud including a plurality of points, each point having velocity information and time-point information;
correcting at least one attribute value related to at least one point included in the velocity point cloud, based on an estimated value at a predetermined time-point; and
adding corrected time-point information indicating the predetermined time-point to the attribute value corrected by the correction and transmitting the corrected attribute value together with the corrected time-point information.

12. An information processing apparatus comprising an execution unit configured to execute a predetermined function in response to a request from an application section, wherein
the execution unit includes:
a reception unit configured to receive, from a first sensor, a velocity point cloud including a plurality of points, each point having velocity information and time-point information;
a correction unit configured to correct at least one attribute value related to at least one point included in the velocity point cloud based on an estimated value at a predetermined time-point; and
an interface unit configured to receive the request from the application section, and
the interface unit
passes the velocity point cloud corrected by the correction unit to the application section in response to the request.

13. The information processing apparatus according to claim 12, wherein
the time-point information indicates a time-point at which each of the plurality of points is acquired by the first sensor.

14. The information processing apparatus according to claim 12, wherein
the predetermined time-point is given as at least one time-point for each frame of a detection operation by the first sensor.

15. The information processing apparatus according to claim 12, wherein
the correction unit
calculates the estimated value based on the velocity information, the time-point information, and inertial measurement data received from a second sensor by the reception unit.

16. The information processing apparatus according to claim 12, wherein
the correction unit
sets at least a moving object velocity point cloud that is a velocity point cloud of moving objects, as a target of the correction.

17. An information processing apparatus comprising:
an application section configured to execute predetermined processing; and
an interface unit configured to pass a request related to the predetermined processing to an execution unit configured to execute a predetermined function, wherein
the application section
receives, via the interface unit, a velocity point cloud that is passed from the execution unit in response to the request and in which at least one attribute value related to at least one point included in the velocity point cloud including a plurality of points each having velocity information and time-point information received by the execution unit from a first sensor is corrected based on an estimated value on a predetermined time-point, and executes the predetermined processing based on the received velocity point cloud.

18. The information processing apparatus according to claim 17, wherein
the application section includes
a map generator configured to generate map information based on a stationary object velocity point cloud that is a velocity point cloud of a stationary object and corrected based on the estimated value, and inertial measurement data received by the execution unit from a second sensor, the stationary object velocity point cloud and the inertial measurement data being individually received via the interface unit.

19. The information processing apparatus according to claim 17, wherein
the application section includes
a region-of-interest extraction unit configured to extract a region of interest on image data received by the execution unit from a third sensor via the interface unit, the extraction being performed based on a region including a moving object, the region including the moving object being estimated based on a moving object velocity point cloud that is a velocity point cloud of a moving object, the moving object velocity point cloud being corrected based on the estimated value and received via the interface unit.

20. The information processing apparatus according to claim 19, wherein
the application section includes
a motion perception unit configured to perceive a motion of the moving object based on combined data obtained by combining the moving object velocity point cloud and image data of the region of interest among the image data.
